(19) United States
(12) Patent Application Publication
(10) Pub. No.: US 2024/0158220 A1
(43) Pub. Date: May 16, 2024

(54) INSERT ASSEMBLIES FOR FLUID DISTRIBUTION AND SYSTEMS AND METHODS OF USE

(71) Applicant: Sonny's HFI Holdings, LLC, Wilmington, DE (US)

(72) Inventors: Ken Martin, Little Canada, MN (US); Connor Findlay, Shakopee, MN (US); Jack Kuckhahn, Prior Lake, MN (US); Alison Kratzke, Stillwater, MN (US); Nate Schlueter, Bloomington, MN (US); Anna Tollefson, Prior Lake, MN (US); Matt Olsen, Bloomington, MN (US); Brandon Hoffman, Shakopee, MN (US); Ethan Kapler, Farmington, MN (US); Caleb Hatch, Prior Lake, MN (US); Jacob Boldenow, Woodbury, MN (US)

(21) Appl. No.: 18/388,399

(22) Filed: Nov. 9, 2023

Related U.S. Application Data
(60) Provisional application No. 63/424,240, filed on Nov. 10, 2022.
(60) Provisional application No. 63/500,418, filed on May 5, 2023.
(60) Provisional application No. 63/500,361, filed on May 5, 2023.

(51) Int. Cl. B67D 7/78; B67D 7/08

(52) U.S. Cl. CPC B67D 7/78; B67D 7/08; B67D 2210/00062

(57) ABSTRACT

An insert assembly for fluid management includes an engagement mechanism and a fluid distribution mechanism with a plurality of fluid connectors configured to transmit fluid therethrough, and a sleeve defining an opening. The fluid distribution mechanism is rotatably coupled to the engagement mechanism such that the two are rotatable relative to each other around a longitudinal axis of the engagement mechanism. An elongated tube extends through the sleeve and at least one valve is coupled to the plurality of fluid connectors by a corresponding fluid line. At a distal end of elongated tube, the elongated tube and valve are coupled via an attachment mechanism, which includes at least one receiving region for releasably receiving the valve. The attachment mechanism, elongated tube and valve form a distal assembly, which distal assembly is configured to be inserted into a port and rest at or near a bottom surface of a covered container.

### CROSS-REFERENCE TO RELATED APPLICATIONS

This application claims priority U.S. provisional patent application No. 63/500,361, filed May 5, 2023, entitled “Insert Assemblies for Fluid Distribution, Systems and Methods of Use,” U.S. provisional patent application No. 63/424,240, filed Nov. 10, 2022, entitled “Optical Time-of-Flight Level Sensing for Car Wash Chemicals,” and U.S. provisional patent application No. 63/500,418, filed May 5, 2023, entitled “Optical Time-of-Flight Level Sensing for Car Wash Chemicals,” each of which is incorporated herein in the entirety and for all purposes.

### TECHNICAL FIELD

The present disclosure relates generally to devices for the management of fluid distribution from containers.

### BACKGROUND

In fluid management, various liquids or fluids such as chemical solutions may be stored in containers, typically barrels, drums or tanks, and may be drawn out and mixed with water and other components to provide a diluted chemical solution to be used for various applications such as cleaning and nutrient delivery in vehicle wash and agricultural applications. Containers such as drums molded of cross-linked, high density polyethylene or drums formed of metal commonly store these chemical solutions and include two openings or bungholes that serve as a means of filling and/or emptying the drum. The openings are generally integrally molded in a top end of the drum and arranged about 180° apart from each other. The openings include threaded vertical walls configured to accommodate a threaded cap such as a conventional bung. Distribution of liquid from the drums can be accomplished using a fluid distribution line inserted into a drum opening, which opening commonly has a small diameter, such as about 2 inches (5.08 cm). As the fluid is dispensed from the drum, the level of fluid remaining can be measured using measuring devices, however, these measuring devices can also require insertion into a drum opening. Due to the small diameter of the opening, use of both a fluid distribution line and a measurement device is commonly performed using separate openings, or when only one opening is present in the drum, the dispensing and measuring operations need to be performed separately.

### SUMMARY

Implementations of the present disclosure provide a compact device for fluid management that can be inserted into a container opening, such as a variety of conventionally sized openings.

According to implementations, an insert assembly may be configured to be coupled to a container having a closed top and an open port, and may include an engagement mechanism with a lower housing portion with an exterior sidewall comprising a coupling configured to be coupled to the port and an upper housing portion configured to engage with the lower housing. A fluid distribution mechanism may be configured to be rotatably arranged between the upper housing portion and the lower housing portion and includes a plurality of fluid connectors configured to transmit fluid therethrough, each of the plurality of fluid connectors may include at least first port configured to be coupled to a first fluid line and at least a second port configured to be coupled to a second fluid line. The insert assembly may further include a sleeve defining an opening. The engagement mechanism and the fluid distribution mechanism may be rotatable relative to each other around a longitudinal axis of the engagement mechanism, and during a coupling operation in which the coupler of the lower housing portion is coupled to the port, the engagement mechanism may be rotatable around the longitudinal axis relative to the fluid distribution mechanism, and after the coupling operation, the fluid distribution mechanism may be rotatable relative to the engagement mechanism and the container.

In various implementations and alternatives, the sleeve may be configured to receive an elongated tube such that the elongated tube extends from an exterior of the container into an interior of the container. In such cases the elongated tube is a component of a sensor assembly.

In various implementations and alternatives, the first fluid line may be configured to extend from an exterior of the insert assembly and distribute fluid from the container, and the second fluid line is configured to extend into a container interior.

In various implementations and alternatives, the coupling comprises at least one threading arrangement defined in the exterior sidewall, and the insert assembly may be configured to be threadedly coupled to the port as the engagement mechanism rotates around the longitudinal axis.

In various implementations and alternatives, the threading arrangement may include a first threading arrangement arranged on a first portion of the sidewall and may have a first thread type, and a second threading arrangement arranged on a second portion of the sidewall and may have a second thread type different from the first thread type.

In various implementations and alternatives, a distal end of each of the second fluid lines may be coupled to a valve assembly. In such cases, the valve assembly may be coupled to a valve attachment mechanism including a receiving region for releasably receiving the valve assembly. In such further cases the insert assembly may additionally include an elongated tube extending through the sleeve, where the valve attachment mechanism may be configured to couple to a distal end of the elongated tube to form a distal assembly, and the distal assembly may be configured to be inserted into the port and rest at or near a bottom surface of the container. In addition, the valve attachment mechanism may be configured to be fixedly arranged along an exterior sidewall of the elongated tube.

In various implementations and alternatives, an elongated tube may extend through the sleeve, and each of the second fluid lines may be coupled to the elongated tube by a tube attachment mechanism, the tube attachment mechanism fixedly arranged along an exterior sidewall of the elongated tube and may include receiving regions for releasably receiving each of the respective second fluid lines, and for the tube attachment mechanism, each of the second fluid lines, and the elongated tube may form a conduit assembly, and the conduit assembly may be configured to be inserted into the port and rest within the container.

In various implementations and alternatives, the plurality of fluid connectors may be arranged on a plate of the fluid distribution mechanism.

In various implementations and alternatives, the fluid distribution mechanism may include a flange extending radially relative to the longitudinal axis, the flange may be supported by and rotatable relative to a bearing surface of the engagement mechanism around the longitudinal axis.

According to other implementations, an insert assembly for fluid management may include an engagement mechanism with a housing and a coupling, a fluid distribution mechanism including a plurality of fluid connectors configured to transmit fluid therethrough and a sleeve defining an opening, where the fluid distribution mechanism may be configured to be rotatably coupled to the housing such that the engagement mechanism and the fluid distribution mechanism are rotatable relative to each other around a longitudinal axis of the engagement mechanism. The insert assembly may further include an elongated tube extending through the sleeve. At least one valve may be coupled to the plurality of the fluid connectors by a corresponding fluid line. An attachment mechanism coupled to a distal end of the elongated tube may include receiving regions for releasably receiving each of the at least one valve, where the attachment mechanism, the elongated tube and the at least one valve form a distal assembly, and where the distal assembly may be configured to be inserted into a port and rest at or near a bottom surface of a covered container.

In various implementations and alternatives, the coupling of the engagement mechanism may be configured to be coupled to corresponding coupling of the port of the covered container, and/or the at least one valve may include a plurality of valves, and/or the at least one valve may be configured as a foot valve.

In various implementations and alternatives, the elongated tube may include a sensor at a proximal end and a cap at the distal end, and the elongated tube may contain a float within an interior thereof. The float may be configured to float on a surface of fluid and the sensor configured to sense a position of the float within the tube for determining a level of fluid in the container, and the cap may be configured to permit fluid to enter and exit the elongated tube and retain the float within the interior of the elongated tube.

According to further implementations, an insert assembly for fluid management may include an engagement mechanism with a housing and a coupling, a fluid distribution mechanism with a plurality of fluid connectors configured to transmit fluid therethrough and a sleeve defining an opening. The fluid distribution mechanism may be configured to be rotatably coupled to the housing such that the engagement mechanism and the fluid distribution mechanism are rotatable relative to each other around a longitudinal axis of the engagement mechanism. An elongated tube may extend through the sleeve and a fluid level sensing system may be coupled to a first end of the elongated tube, which includes a sensing system with a control unit containing a processor and a sensor communicatively coupled to the processor. A float arranged in the elongated tube may be configured to be movable. The sensor may be configured to transmit signals to sense a distance between the sensor and the float arranged in the elongated tube when the elongated tube is arranged in a container containing a fluid undergoing egress therefrom such that a level of a fluid within the elongated tube corresponds to a level of the fluid in the container. Based on a sensed distance between the sensor and the float, the processor may be configured to calculate a level of the fluid present in the container during such egress.

In various implementations and alternatives, the processor or another processor may be communicatively coupled to a metering device configured to adjust the rate of egress of the fluid and/or may be communicatively coupled to a flow rate sensor configured sense a flow rate of the fluid contained in a fluid line as the fluid exits the fluid distribution mechanism.

### BRIEF DESCRIPTION OF THE DRAWINGS

FIG. 1 is an isometric view of an insert assembly of the present disclosure arranged in a barrel.

FIG. 2A is an isometric view of the insert assembly of FIG. 1.

FIG. 2B is an exploded view of the insert assembly of FIG. 2A.

FIG. 2C is a partial isometric view of the insert assembly of FIG. 2A.

FIG. 2D is a partial section plan view of the insert assembly of FIG. 2A including portions of an engagement mechanism and a fluid distribution mechanism.

FIG. 2E is a bottom, left isometric view of the engagement mechanism and fluid distribution mechanism of the insert assembly of FIG. 2A.

FIG. 2F is an isometric view of an attachment mechanism and an elongated tube of the insert assembly of FIG. 2A.

FIG. 2G is an isometric view of nozzle assemblies and another attachment mechanism of the insert assembly of FIG. 2A.

FIG. 2H is a bottom, right isometric view of the nozzle assemblies and a cap at a distal end of the elongated tube of the insert assembly of FIG. 2A.

FIG. 2I is a section isometric view of a nozzle assembly of the insert assembly of FIG. 2A.

FIG. 3 is a system diagram of a level sensing system that includes multiple level-sensing devices that may include the insert assembly of the present disclosure, according to the present disclosure.

FIG. 4 is a side view of an example float device, according to the present disclosure.

FIG. 5 is a side view of a second example of a float device, according to the present disclosure.

FIGS. 6A1, 6A2 and 6B depict various views of a control unit of an optical level-sensing device, according to embodiments of the disclosure.

FIG. 6C depicts a control unit of an optical level-sensing device, according to variants of the disclosure.

FIG. 7 depicts a cross-section of the elongated tube and a cross-section of the float device, according to the present disclosure.

FIG. 8A illustrates a dilution control system that may be integrated with the level sensing systems, according to the present disclosure.

FIG. 8B illustrates a dilution control system that may be integrated with the level sensing systems, according to the present disclosure.

### DETAILED DESCRIPTION

This disclosure describes an insert assembly with an engagement mechanism and a fluid distribution mechanism for extracting fluid from a container. The insert assembly may optionally be used with a sensor assembly for measuring a level of a fluid, e.g., viscous or liquid chemical, in the container over time. The sensor assembly may be a component of the insert assembly and may sense a target surface, which may be a top surface of a float device contained within the insert assembly. The sensor may be configured to emit optical signals, sound signals, and so forth and to sense such when reflected back from the target surface of the float device. Based on the return time, the sensing device may calculate a current level of the fluid within the container.

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

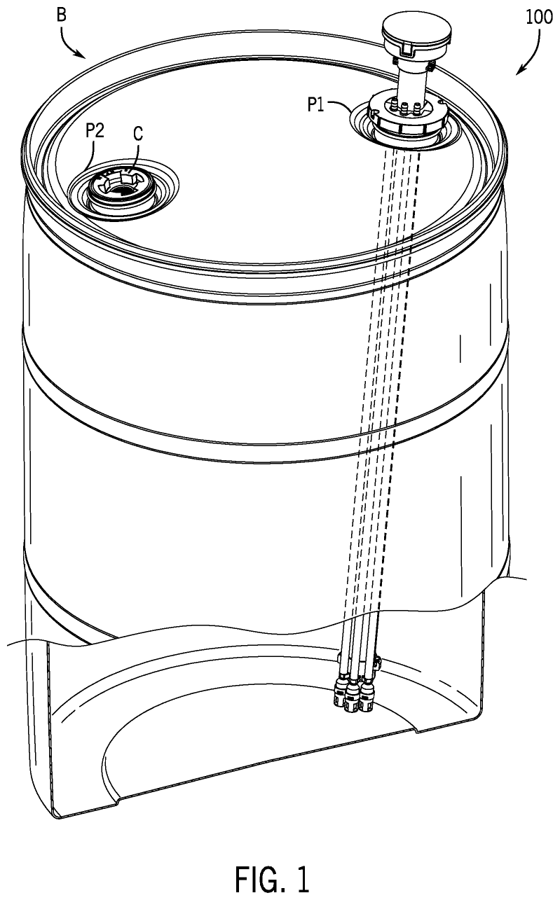

FIG. 1 is an isometric view of the insert assembly 100 of the present disclosure in use in a barrel B, also referred to as a container, having a bottom portion cut away to show the insert assembly 100 arranged therein. The containers used in connection with the insert assemblies of the present disclosure may be conventional barrels, drums or tanks having a cylindrical shape, or storage containers, with a closed or covered top and one or more access openings or ports, P1, P2 (e.g., bungholes), or may be specially configured containers with a closed top and one or more access openings. The access openings of the containers may be integrally molded or formed with the container. The access openings, e.g., ports P1, P2, may initially be sealed by a cap C, such as a conventional bung. The containers are configured to securely hold and enclose contents, including fluids such as concentrated chemicals and other liquids, and may be constructed of molded of cross-linked, high density polyethylene, metal, or other materials resistant to degradation. The access openings or ports P1, P2 may provide the means for filling and/or emptying the container and may include a coupling such as threaded sidewalls configured to accommodate threads of the cap C. According to the present disclosure, the insert assemblies 100 may be received in one or more of the access openings of the container by inserting a distal end of the insert assembly 100 into the access opening and coupling a proximal end of the insert assembly to a coupling of the access opening or port of the container. For instance, a threaded opening of the container may include standard NPS threads used in conventional drums. In another implementation, a proximal end of the insert assembly may be coupled to the container at the container opening by self-tapping screws. The opening may be adapted to receive a cap having a small diameter, such as 0.75 (19 mm) to 4.0 in. (102 mm), including caps having about a 2.0 in. (50 mm) to about a 3.0 in. (76 mm) diameter, about a 2.0 in. (50 mm) to about a 2.50 in. (63 mm) diameter, about a 2.50 in. (63 mm) to about a 2.75 in. (70 mm) diameter, or about a 1.0 in., 1.5 in., 2.0 in., 2.25 in., 2.50 in, 2.75 in. 3.0 in., 3.25 in, 3.50 in., 3.75 in. diameter. Accordingly, the components of the insert assemblies 100 described herein may be configured to be receivable by these small diameter openings of the container. Upon coupling the insert assembly 100 to the container, a distal end of the insert assembly may come to rest at or near a bottom of the container as illustrated in FIG. 1. By providing insert assemblies 100 that can be inserted into the container opening, along with the fluid management functions as disclosed herein, this offers the ability to maintain the integrity of use applications in which the container contents are distributed to multiple locations from multiple distribution lines of the insert assembly 100 arranged within the container, such as in the continuous operation of vehicle washes or consistent nutrient delivery in agricultural operations. Further, where the insert assemblies 100 are configured to manage fluids using level sensors, implementations may facilitate preventing the depletion of the contents, such as concentrated chemical solutions.

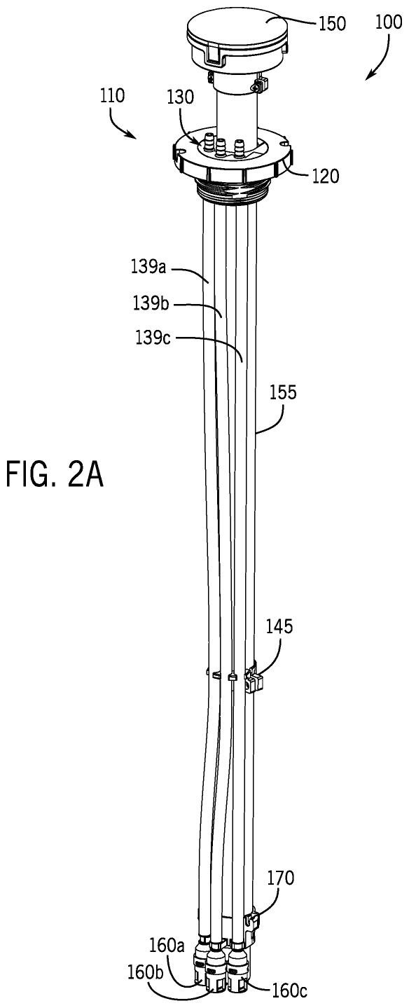

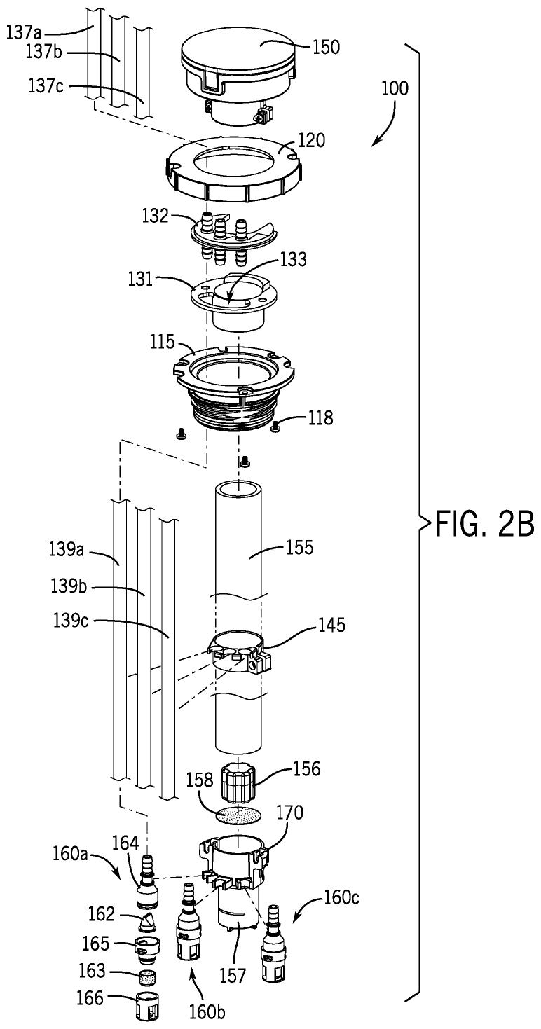

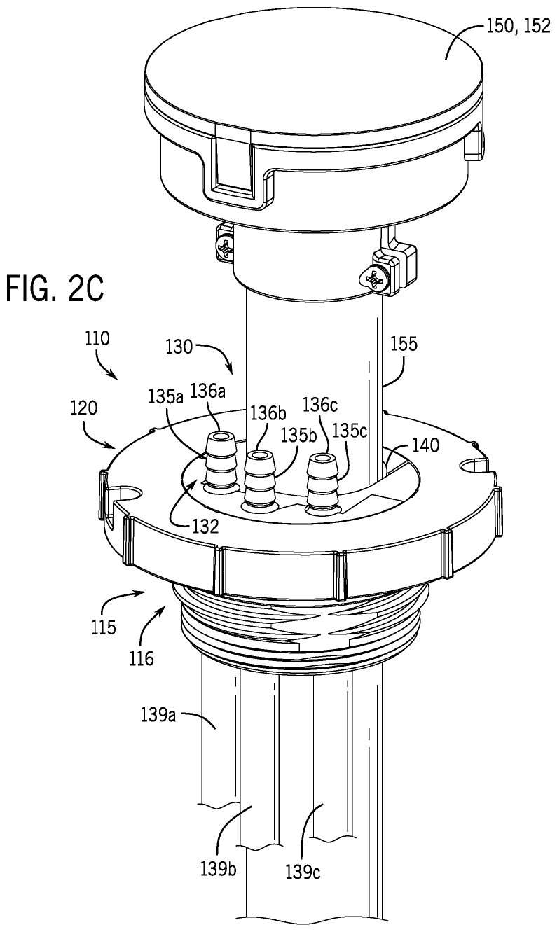

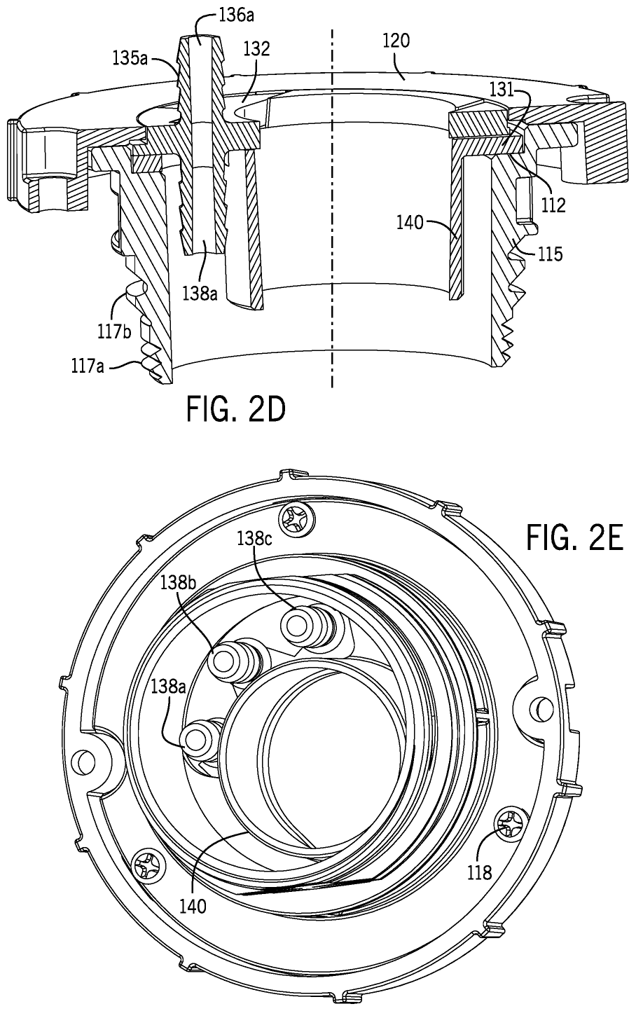

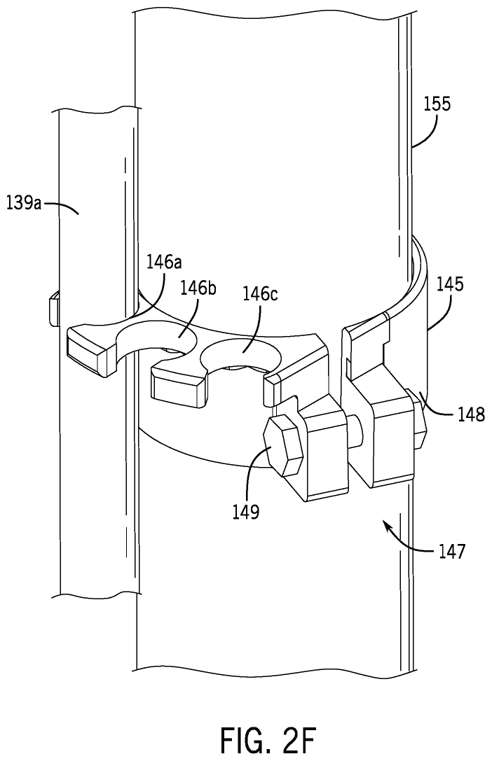

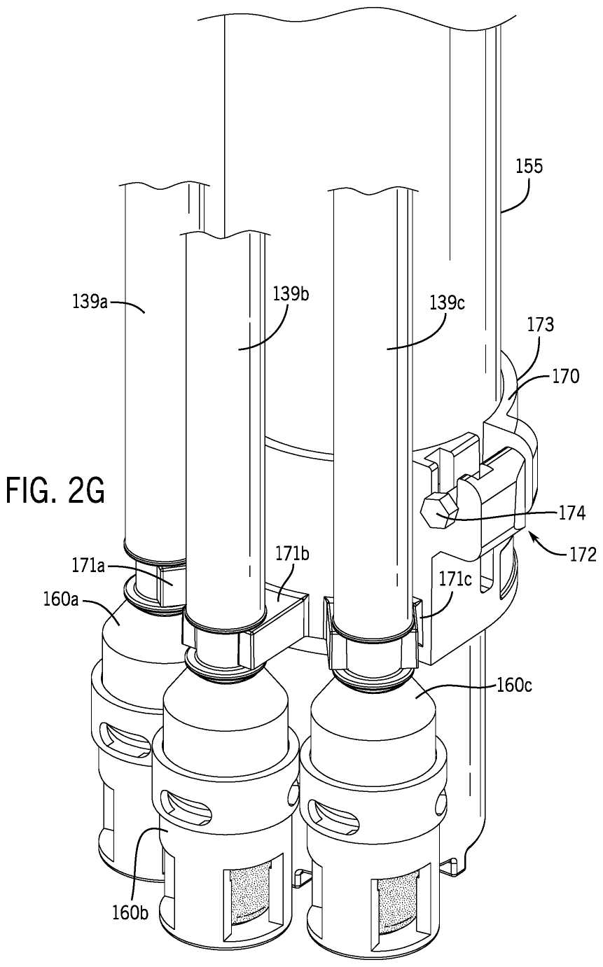

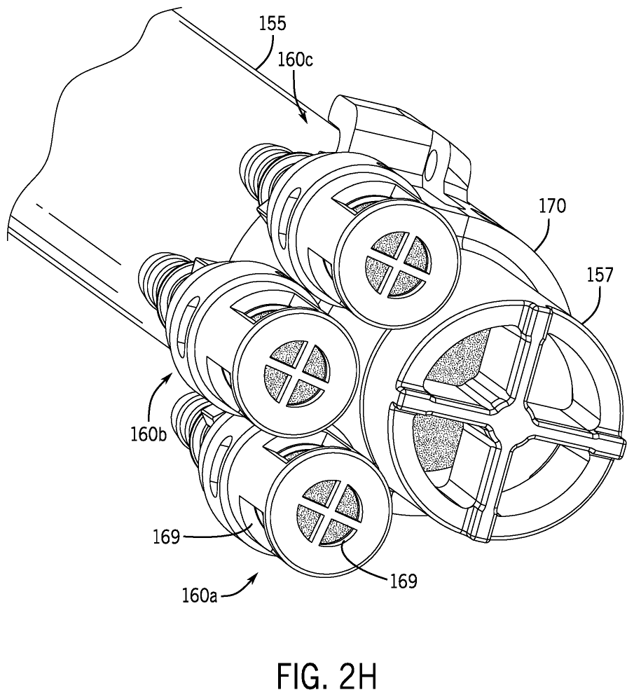

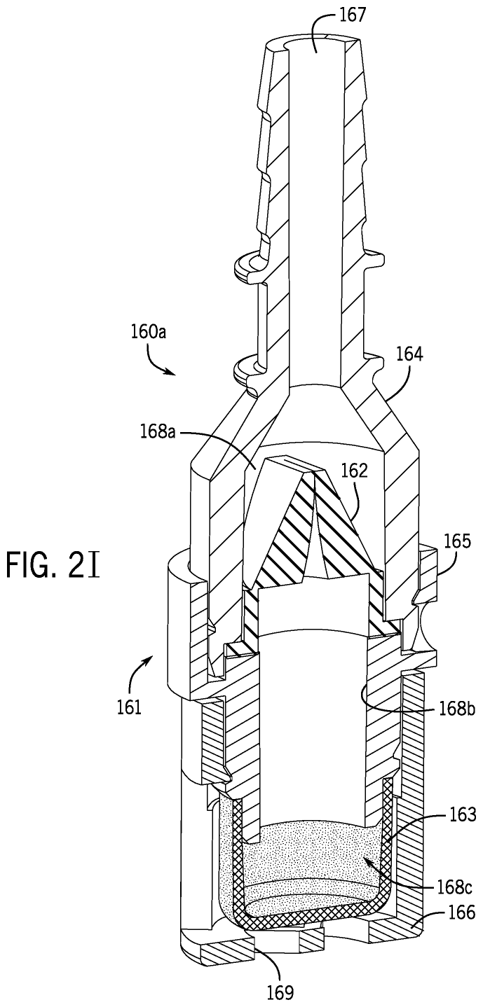

Turning to FIGS. 2A, 2B and 2C, the insert assembly 100 may include an engagement mechanism 110 with a lower and an upper housing portion 115, 120, a fluid distribution mechanism 130 including a plurality of fluid connectors 135a, 135b, 135c and a sleeve 140 defining an opening, a fluid line or tube attachment mechanism 145, a sensor assembly 150, an elongated tube 155, one or more valve assemblies 160a, 160b, 160c, and a valve attachment mechanism 170.

The engagement mechanism 110 of the insert assembly 100 may include a housing configured to couple to the access opening or port of the container, e.g., barrel B, as well as to receive portions of the fluid distribution mechanism 130. For instance, a lower housing portion 115 of the engagement mechanism 110 may include an exterior sidewall with a coupling 116 configured to be coupled to the opening or port of the container. As illustrated in FIG. 2D, the coupling 116 of the engagement mechanism 110 may include at least one threading arrangement 117a defined in the exterior sidewall, which for instance may be configured with a first thread type for being threadedly coupled to a first type of port of a container. As further illustrated, the coupling 116 may additionally include a second threading arrangement 117b having a second thread type different from the first thread type, which for instance may be configured to be threadedly coupled to a second type of port. The threading arrangements 117a and 117b may be arranged on separate portions of the sidewall of the engagement mechanism 110 e.g., along a respective first portion and second portion of the lower housing portion 115, which may facilitate use of the insert assembly in multiple container types having openings or ports with differing threaded arrangements. For instance, the threading arrangement 117a may be a fine thread, while the threading arrangement 117b may be a coarse thread. In a particular example, the threading arrangement 117a may be configured to be received by a NPS (National Pipe Straight) container thread, e.g., having about a 2 in. diameter, while the threading arrangement 117b may be configured to be received by a Buttress container thread having a larger diameter, e.g., having about a 2.5 in. diameter.

Although the engagement mechanism 110 is shown in FIG. 2D as having a coupling 116 with a threaded exterior, the coupling 116 can be engaged using any suitable connection, including, for example, quick connections including compression or twist style engagement mechanisms, z-thread or quarter turn engagement mechanisms, snap detent mechanisms, clamp assemblies, and the like.

An upper housing portion 120 of the engagement mechanism 110 may be configured to couple or engage with the lower housing portion 115 such as by fasteners 118, which may include screws, bolts, or any suitable connection including, for example, quick connections as described herein. The upper housing portion 120 may be configured as an exterior housing portion of the insert assembly 100 and for instance may have a shape configured to cover or enclose an outer circumference of variously designed container openings or ports, e.g., ports P2 or P2.

The fluid distribution mechanism 130 of the insert assembly 100 may be configured to be arranged within the engagement mechanism 110 and rotatable around a longitudinal axis of the engagement mechanism 110. Due to this rotational arrangement, during a coupling operation in which engagement mechanism is coupled to the container, e.g., the coupling 116 of the engagement mechanism is coupled to a port P1 or P2, the engagement mechanism 110 is rotatable around the longitudinal axis (FIG. 2D) relative to the fluid distribution mechanism to complete the coupling operation. For instance, the coupling operation may involve screwing the coupling 116 into a complementary threading of the port P1 or P2. After the coupling operation, the fluid distribution mechanism 130 may be rotatable relative to the engagement mechanism 110 and thus relative to the container on which the insert assembly 100 is coupled.

In some implementations, the fluid distribution mechanism 130 or a portion thereof may be received between the lower and upper housing portions 115, 120 such that the fluid distribution mechanism 130 and the engagement mechanism 110 are rotatable. In a particular example, and with reference to FIG. 2D, the fluid distribution mechanism 130 may include a flange 131 (FIG. 2D) extending radially relative to a longitudinal axis of the insert assembly 100. The flange 131 may be supported by and rotatable relative to a bearing surface 112 of the engagement mechanism 110 around the longitudinal axis, and for instance, the bearing surface 112 may be configured as a ring-shaped surface on the lower housing portion 115, while the flange 131 may also be ring-shaped as illustrated in FIG. 2B. The flange 131 and components coupled thereto may for instance be rotatable bi-directionally relative to the engagement mechanism 110, or alternatively, may be rotatable in one direction, for instance by providing an engagement mechanism configured to permit rotation of the flange 131 in one direction relative to the bearing surface but prevent rotation in an opposite direction.

The fluid distribution mechanism 130 includes a plurality of fluid connectors 135a, 135b, 135c that may extend through the fluid distribution mechanism 130 and be configured to transmit fluid therethrough such that fluid can be delivered from the interior of the container via fluid lines fluidly coupled to these fluid connectors 135a-135c. The plurality of fluid connectors 135a-135c may be configured with hose barbs or with any suitable shape for engaging with and retaining fluid lines, such as flexible hoses. Each of the plurality of fluid connectors 135a-135c may include first port 136a, 136b, 136c configured to be coupled to a respective first fluid line 137a, 137b, 137c, as well as a second port 138a, 138b, 138c configured to be coupled to a respective second fluid line 139a, 139b, 139c. The first fluid lines 137a-137c coupled to the first ports 136a-136c may be configured to extend from an exterior of the insert assembly 110 and distribute fluid from the container when coupled with the insert assembly 100. The second fluid lines 139a-139c may be configured to extend into the container interior and transmit fluid from the container interior to the fluid connectors 135a-135c, and may also couple to other fluid management components of the insert assembly 100 provided herein. The fluid lines may be constructed of materials adapted to withstand degradation by the concentrated chemicals and/or may be adapted to protect the concentrated chemicals from degradation such from UV-light, from bacterial growth, or from high or low temperatures. For instance, one or more of the fluid lines may be opaque to prevent penetration of UV-light and/or bacterial growth, may be insulated to maintain a desired temperature range, and so on.

Although the fluid distribution mechanism 130 is illustrated as including three fluid connectors 135a-135c, the fluid distribution mechanism 130, as well as the insert assemblies 100, of the present disclosure may include more or less than three fluid connectors, such as one, two, four, five, six, seven eight, nine, ten, eleven, twelve or more fluid connectors. The fluid distribution mechanism 130 may accordingly include or be associated with a corresponding number of first and second fluid lines. In addition, although the fluid connectors 135a-135c are illustrated as each having a single first port and single second port, a fluid connector may include multiple first ports and/or multiple second ports. For instance, a fluid connector may include a plurality of first ports and a single second port with branches leading to each of the first ports. Such a configuration may enable fewer second fluid lines to extend into the container while distributing fluid out the container from multiple first fluid lines.

In some implementations, the fluid distribution mechanism 130 may include a plate 132 on which the plurality of fluid connectors 135a-135c are arranged. As illustrated in FIG. 2B, the plate 132 may be configured to hold the fluid connectors 135a-135c, such as at a pre-defined angle or arrangement relative to each other, e.g., parallel to a longitudinal axis of the insert assembly 100 and in a semi-circular arrangement. The plate 132 may be shaped to be received by the flange 131. For instance, the plate may be C-shaped and a portion of the flange 131 configured for receiving the plate 132 may include a corresponding receiving region with an opening 133 defined therein configured for receiving the second ports 138a-138c of the plurality of fluid connectors 135a-135c (FIG. 2E).

A sleeve 140 of the fluid distribution mechanism 130 may define an opening through the fluid distribution mechanism and may be configured to provide an access opening of the insert assembly 100 separate from the plurality of fluid connectors 135a-135c (FIGS. 2D and 2E). The sleeve 140 may be defined in the flange 131 and may be configured to receive various fluid management components such as an elongated tube 155 (e.g., FIGS. 2C and 2D) or additional fluid lines. The fluid management components may extend from an exterior of the container, through the sleeve 140, and into an interior of container.

The elongated tube 155 may be slidably insertable into the sleeve 140 via a distal end of the elongated tube 155 being inserted in a proximal end of the sleeve 140, and the elongated tube 155 may include or may receive a collar near a proximal end in an area where the elongated tube 155 is to remain at a top or exterior portion of the insert assembly 100 as shown in FIGS. 1 and 2A. The elongated tube 155 may be partially slidable within the sleeve 140 to allow a certain amount of axial play for containers having differing depths. The elongated tube 155 may have a length that is greater than a height of the container, e.g., barrel B. In some examples, the elongated tube 155 may be opaque to prevent the sensor signals, such as optical signals, from escaping the elongated tube 155 and/or to prevent stray reflections that may occur should the elongated tube 155 be transparent.

Consistent with the present disclosure, plurality of fluid connectors 135a-135c and the sleeve 140 may be coupled such that the engagement mechanism 110 and the fluid distribution mechanism 130 are rotatable relative to each other around the longitudinal axis of the engagement mechanism. For instance the flange 131 defining the sleeve 140, and the plate 132 carrying the plurality of fluid connectors 135a-135c, may be coupled or fixed to each other so as to fluid distribution mechanism 130 rotatable relative to the engagement mechanism 110.

Referring to FIG. 2F, one or more tube attachment mechanisms 145 may be provided in connection with the insert assembly 100. The tube attachment mechanism 145 may facilitate compact organization of one or more fluid lines, e.g., the second fluid lines 139a-139c, and may include a corresponding number of receiving regions, e.g., receiving regions 146a, 146b, 146c for releasably receiving one of or each of the respective fluid lines. In implementations where an elongated tube 155 extends through the sleeve 140 of the insert assembly 100, the tube attachment mechanism 145 may be fixedly arranged along an exterior sidewall of the elongated tube 155. Alternatively, an elongated rod may extend through the sleeve 140 and function similarly to the elongated tube 155 with respect to coupling to the tube attachment mechanism, but may not include a tubular interior. The elongated rod or tube 155 may be constructed of a rigid material and thus impart rigidity to the insert assembly 100. In some implementations the attachment mechanism 145 is configured with a closure 147 and a collar 148 for coupling the attachment mechanism to the elongated tube 155 or rod. For instance the closure 147 may be configured as a fastening arrangement 149 such as a clamp or a cam lock, e.g., clamping handle coupled to a split ring or clamp, for establishing a pinch, compression, and/or friction lock for releasably coupling the attachment mechanism 145 to the elongated tube 155 or rod. Alternatively, the closure 147 may be through any suitable fastening arrangement 149 such as a threaded nut and bolt. According to certain implementations the tube attachment mechanism, each of the first fluid lines, and the elongated tube or rod may form a conduit assembly, and the conduit assembly may be configured to be inserted into the opening of the container, e.g., port P1 or P2 and rest within the container.

A sensor assembly 150 may be provided in connection with the insert assembly 100 and configured to sense a level of fluid in the insert assembly 100. The sensor assembly 150 may include a sensor and control unit 152, the elongated tube 155, a float device 156, a cap 157 and a filter 158 at a distal end of the elongated tube 155. The sensor and control unit 152 of the sensor assembly 150 may be arranged at a proximal end of the elongated tube at an exterior of the container when the insert assembly 100 is attached thereto, while the float device 156 may be contained within an interior of the elongated tube 155. The float device 156 may be configured to float on a surface of fluid (e.g., a liquid chemical solution) within the tube, and the sensor assembly 150 may be configured to sense a position of the float device 156 within the elongated tube 155. In some examples, the float device may be constructed of a durable, chemically resistant polymer such as high density polyethylene (HDPE), polyether ether ketone (PEEK) and variations and combinations thereof. In some implementations, the sensor assembly 150 is configured as an optical time-of-flight sensor assembly, however, other sensor types are within the scope of the present disclosure, such as ultrasonic sensors. Other sensor types may include but are not limited to capacitive, radar, and pressure transducer sensors. The cap 157 may be configured to permit fluid to enter and exit the elongated tube 155 (FIG. 2H), and a level of fluid therein may thus correspond to a level of fluid in the container. In some examples, the cap 157 may include side perforations/apertures/holes and/or notches cut out of a bottom surface to allow the fluid to flow into or out of the elongated tube 155 as the level in the container changes. The cap 157 may also serve to retain the float within the interior of the elongated tube 155 so that the insert assembly 100 can be easily installed into and removed from a container without loss of the float 156. The cap 157 may include a standoff separating the elongated tube 155 from the bottom of the container to at least slightly separate the insert assembly 100 from a bottom surface of the container, to thereby facilitate fluid ingress and egress from the elongated tube 155. The fluid openings may be sized so as to hold the float 156 within the elongated tube and prevent escape. The filter 158 may prevent contaminants from entering the elongated tube 155.

Referring to FIGS. 2G, 2H, and 2I, the insert assembly 100 may include one or more valve assemblies 160a, 160b, 160c, which valve(s) may be configured to be inserted simultaneously into the container via the container opening or port, along with the other components of the insert assembly 100, as provided herein. The valve assemblies 160a-160c may each be configured to couple to one or more fluid lines, such as respective second fluid lines 139a-139c, and the valve assemblies 160a-160c may be used for drawing-in fluid from the container into which the insert assembly 100 is inserted.

The valve assemblies 160a-160c may include a valve housing 161 with two or more housing components, a valve 162 and a filter 163. The valve housing 161 illustrated in FIG. 2I includes an upper housing 164, a middle housing 165, and a lower housing 166. The upper housing 164 may be configured with a fluid outlet 167 for coupling to a fluid line, such as the second fluid line 139a, and with an upper housing chamber 168a configured to receive the valve 162. Although the upper housing 164 is illustrated as including a single fluid outlet 167, the valve housing 161 of the insert assemblies of the present disclosure may include multiple fluid outlets 167 for coupling to multiple fluid lines, such as second fluid lines 139a-139c. For instance, the upper housing 164 may include multiple fluid outlets 167 for coupling to multiple fluid lines. The valve 162 may be seated between the upper housing 164 and another housing component, and in FIG. 2I, the valve 162 is seated against the upper and middle housing 164, 165 and the housing components may form a fluid tight seal with the valve 162. In addition to seating the valve 162, the middle housing 165 may be configured to be received between the upper and lower housings 164, 166 and define an opening 168b though which fluid can be drawn as it enters the valve housing 161 via the lower housing 166. The lower housing 166 may be configured to couple to one or both of the valve housings 164, 165 and define an internal chamber 168c with openings 169, e.g., intake openings permitting fluid to flow into the valve housing 161 (FIGS. 2H and 2I). The filter 163 may be arranged within the internal chamber 168c and may function to filter sediment from the fluid before entering the valve housing 161. In some implementations, a filter may be integrally formed with a component of the valve housing 161. In such implementations, it will be understood that the valve housing 161 may optionally be configured without one of the housings, such as the middle housing 165. Although FIG. 2I illustrates the valve assembly 160a, it will be understood that the other valve assemblies disclosed herein may be configured substantially the same. The valve assemblies 160a-160c of the present disclosure may be configured to be relatively more compact than traditional valves, such as traditional foot valves. The compact nature of the valve assemblies 160a-160c may enable their simultaneous insertion, along with other fluid management components disclosed herein, into the traditionally small container openings. Although three valve assemblies 160a-160c are illustrated in the figures, the insert assemblies 100 of the present disclosure may include more or less than three valve assemblies, such as one, two, four, five, six, seven, eight, nine, ten, eleven, twelve or more valve assemblies.

In some implementations, valve 162 of the valve assemblies 160a-160c of the present disclosure may be configured as a one-way valve or check valve and may function to provide a unidirectional flow of fluid into the fluid lines of the insert assembly 100 while preventing backflow. One-way valves that may be included in the valve assemblies 160a-160c of the present disclosure include but are not limited to: duckbill valves, umbrella valves, dome valves, cross-slit valves, Belleville valves, and so on. A duckbill valve is illustrated in FIG. 2I and may be used in some implementations due to this valve type having a low opening pressure, and for instance may be preferred over umbrella valves due to the duckbill valve providing a relatively more linear fluid flow into the valve assembly. In addition, the duckbill valve may operate more efficient than the industry standard. In a particular example, the valve assemblies 160a-160c may be compactly designed as foot valves. Foot valves may be useful due to this valve type being used for drawing in fluid from the container upon the foot valve being subjected to a pressure differential, for instance in connection with the operation of a metering device, e.g., pump, coupled to the fluid lines for causing fluid to be drawing into the valve assemblies 160a-160c. The valve assemblies 160a-160c may alternatively be configured as other valve assembly types such as a check valve, for instance where the valve assembly is used to deliver fluid into the barrels of the present disclosure. The valve assemblies 160a-160c may be made of chemically compatible materials.

The upper housing 164, middle housing 165, and lower housing 166 of the valve assemblies 160a-160c may be engaged using any suitable connection including, for example, quick connections described herein.

Referring again to FIGS. 2G and 2H, the insert assembly 100 may include a valve attachment mechanism 170 including one or more receiving regions, e.g., receiving regions 171a, 171b, and 171c, for releasably receiving one or more valve assemblies, e.g., the respective valve assemblies 160a-160c. The valve attachment mechanism 170 may be configured to couple to a distal end of the elongated tube 155. For instance, the valve attachment mechanism 170 may be configured with a closure 172 and a collar 173 for coupling the valve attachment mechanism 170 to the exterior sidewall of the elongated tube 155 or an elongated rod. For instance the closure 172 may be configured with a fastening arrangement 174 such as a clamp or a cam lock as described herein for releasably coupling the valve attachment mechanism 170 to the elongated tube 155. Alternatively, the coupling may be through any suitable fastening arrangement such as a threaded nut and bolt. In some implementations, the cap 157 may be integral with the valve attachment mechanism 170 (FIG. 2B). The valve attachment mechanism 170, the elongated tube 155 along with the components coupled to the valve attachment mechanism 170, e.g., the valve assemblies 160a-160c, may be configured to be inserted as a unit or as a distal assembly into the opening of the container, e.g., e.g., P1 or P2, and rest at or near a bottom surface of the barrel.

During installation, a distal end of the insert assembly 100 may be inserted into the opening of a container such that the distal assembly is inserted into an interior of the container until the engagement mechanism 110 contacts the container opening, e.g., P1 or P2. During the insertion movement, and due to the insert assembly 100 having an overall diameter that is less than an internal diameter of the container opening, the insert assembly 100 may not be obstructed by the container opening thus allowing its full insertion into the container. The engagement mechanism 110 may be coupled with the coupling of the container, such as by screwing threading of the insert assembly 100 onto threads of the container opening. During this coupling, the engagement mechanism 110 may be rotatably arranged about the fluid distribution mechanism 130, and due to the fluid distribution mechanism 130 being at least rotationally fixedly coupled to the elongated tube 155 and thereby to the attachment mechanisms 145 and 170, the fluid management components coupled to the fluid distribution mechanism 130 such as the fluid lines 137a-137c and 139a-139c and the sensor assembly 150, may remain stationary and may serve as a stator for the user to hold while the engagement mechanism 110 is coupled to the container opening, e.g., by the user rotating and optionally screwing the engagement mechanism 110 around its longitudinal axis into the opening. Upon completion of the engagement, the fluid distribution mechanism 130 and the components coupled thereto may be rotated about the longitudinal axis of the engagement mechanism 110, which for instance enables the containers with their insert assemblies 100 to be moved or rotated, while the fluid distribution mechanism 130 may remain it its initial position or be partially rotated for instance depending on external connection to the fluid distribution mechanism 130. The ability for the fluid distribution mechanism 130 to rotate when installed in the container can avoiding tangling of the various fluid lines and electrical lines (e.g., coupled to a power source of the sensor assembly 150) that may be coupled thereto. In addition, the insert assemblies of the present disclosure may allow the installer to have control of the chemical lines with one hand, allowing attachment/detachment of the engagement mechanism with the other hand, which allows the installer to avoid crossing the chemical lines during the installation, e.g., unscrewing the engagement mechanism is permitted while the installer is able to hold the fluid distribution mechanism and its fluid lines stationary.

In operation, the fluid distribution mechanism 130 of the insert assembly 100 may be coupled to one or more metering devices, such as a pinch valve or a positive displacement pump. For instance, the first fluid lines 137a-137c may be configured as in-feed lines for one or more chemical delivery systems, and each fluid line may deliver a fluid such as a concentrated chemical from the container, e.g., barrel B, upon actuation of a respective metering device. A pinch valve may operate to widen or narrow an orifice to permit more or less fluid, e.g., concentrated chemical, to pass through the in-feed and into a respective eductor or other component of the chemical delivery system to adjust a metering rate of the fluid from the container. In such examples, a pump may provide vacuum pressure for causing fluid to be drawn into the fluid distribution mechanism 130. In another example, a positive displacement pump, such as a peristaltic pump, may positively displace fluid over an impingement path where the in-feed lines may be impinged upon during operation, and the rate of fluid displacement may be adjusted to increase or decrease a rate of fluid delivery from the respective fluid lines of the insert assembly 100, e.g., fluid lines 137a-137c.

Operation of a respective metering device coupled to one of the first fluid lines 137a-137c may cause a pressure drop to create a partial vacuum that draws fluid into the fluid distribution mechanism 130 from the container interior at a respective one of the valve assemblies 160a-160c, then traveling through a respective one of the second fluid lines 139a-139c, to the respective one of the fluid connectors 135a-135c, and then the through the respective one of the first fluid lines 137a-137c configured as the in-feed lines for the solution delivery system having the metering device. It will be understood that a metering device may be coupled to the first fluid lines 137a-137c, such as two or more of the first fluid lines 137a-137c.

During a fluid delivery operation, such as a dilution operation during which fluid is drawn from the container and diluted downstream of the first fluid lines 137a-137c, a level of fluid in the container may be gradually depleted. In addition due to various metering devices coupled to these fluid lines and being operating at different metering rates, combined with a level of fluid within a container being variable (e.g., due to refilling frequencies, or container change frequencies) a rate of depletion of the fluid from the container may be unpredictable. Accordingly, the sensor assembly 150 of the present disclosure may be used to sense a level of fluid in the container to facilitate preventing the depletion of the contents, such as chemical solutions. For instance, the sensor and control unit 152 of the sensor assembly 150 may be configured to transmit signals to sense a distance between a sensor of the sensor and control unit 152 and the float 156 arranged in the elongated tube 155 when the elongated tube 155 is arranged in the storage container containing the fluid, e.g., the liquid chemical solution. Due to the distal or bottom end of the elongated tube 155 being configured to allow fluid ingress and egress, a level of the fluid within the elongated tube may correspond to a level of the fluid in the container. Based on a sensed distance between the sensor and the float 156, a processor of the sensor and control unit 152 may be configured to calculate a level of the fluid present in the container. The sensor and control unit 152 may include an optical time-of-flight sensor, an ultrasonic sensor, a capacitive sensor, a radar, and/or a pressure transducer sensor. The level of fluid sensed by the sensor assembly 150 may be used by the sensor assembly 150 and components communicatively coupled thereto for instance to determine whether operational parameters of the fluid management components fluidly coupled to the insert assembly 100 should be modified and/or if one or more containers fluidly coupled to a corresponding insert assembly 100 associated with the sensor assembly 150 should be replaced or the fluid therein be replenished.

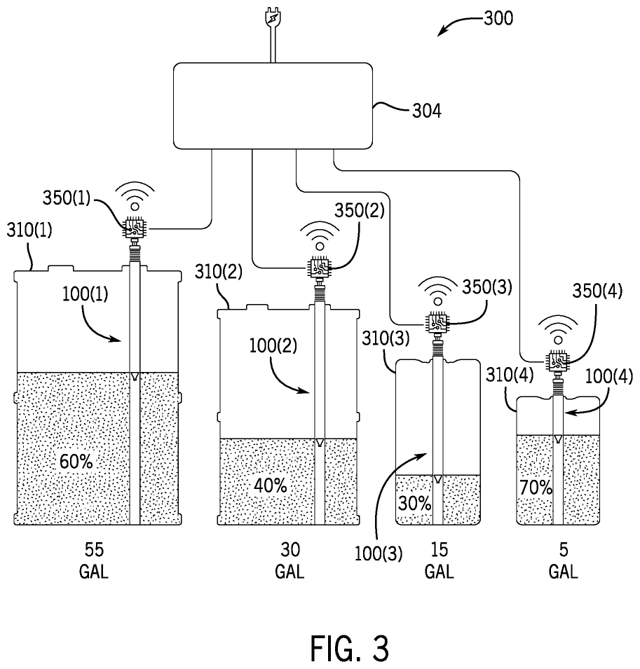

FIG. 3 is a system diagram of a level sensing system 300 that includes multiple level-sensing devices 350(1)-(4), according to embodiments of the disclosure. The insert assemblies 100(1)-(4) and the sensor assemblies 150 may implement the level-sensing devices 350(1)-(4), in some examples. Each of the level-sensing devices 350(1)-(4) may be inserted into a respective storage container 310(1)-(4), e.g., barrel B, to detect a fluid level therein. A power box or supply 304 may provide power to the level-sensing devices 350(1)-(4) to power circuitry of the level-sensing devices 350(1)-(4). The power distribution box or supply 304 may be configured as a breaker box, a power store such as a battery, or other source of power such as via an electrical connection.

Each of the level-sensing devices 350(1)-(4) may be coupled to an elongated tube 155 of the respective insert assembly 100(1)-(4). The float devices 156 may be retained in the elongated tube 155 and serve to float in the fluid and provide a target surface for the sensor of the level-sensing devices 350(1)-(4) to detect. As shown in FIG. 3, the float device 156 may be even with a top surface of the fluid and oriented substantially perpendicular to a direction where signals are transmitted from the sensor, but the float device 156 may also be above a top surface of the fluid and oriented substantially perpendicular to a direction where signals are transmitted from the sensor. The level-sensing devices 350(1)-(4) may each be coupled to an upper or top end of the elongated tube 155 and attached control unit located a short distance above a top of the respective storage container 310(1)-(4). The engagement mechanism 110 of the insert assembly, e.g., 100(1), may be slid up and down the elongated tube 155, and when installed, may remain at an exterior of the respective storage container 310(1)-(4) and may attach to the container opening as already disclosed.

The target surface formed on a top face of the float device 156 may have a surface area that is based on a cross-sectional surface area formed by interior or inside walls of the elongated tube 155. An outer-most diameter of the target surface of the float device 156 may be slightly less than an inner diameter of the elongated tube such that the float device is free to move vertically within the elongated tube as the level of the fluid (e.g., viscous or liquid chemical) changes, while also providing a large target surface for the sensor. In some examples, the target surface may consume the entire top face of the float device.

Along with an outermost diameter of the float device 156 being only slightly smaller than the cross sectional diameter of the elongated tube 155, the float device 156 may have a center of buoyancy and a center of gravity that maintains the target surface in an upward-facing direction. In some examples, the float device 156 may include other features to hold the target surface substantially perpendicular to the direction of the sensor signals transmitted from the sensor when the reservoir is titled at a slight angle. In some examples, the float device 156 may have vertical splined sidewalls formed between symmetrical top and bottom surfaces. In another example, the float device 156 may be a conical shape starting with a larger radius at the target surface to a smaller area next to a base. In this example float device 156, the base of the float device may have a sufficient size and mass to maintain the center of buoyancy to maintain the target surface in an upward-facing direction. In this example float device, the base may have a star-like shape, with an outer-most radius formed by the star being slightly smaller than the inside radius of the elongated tube. In some examples, the axial length of the float device 156 is greater than a radius of the target surface.

The control unit of the level-sensing devices 350(1)-(4) (e.g., control unit) may have a sealed outer housing containing the sensor and may be mounted on the second (e.g., upper or top) end of the elongated tube 155, with the elongated tube 155 supporting the control unit. The control unit may include a physical barrier between the sensor and the opening at the end of the elongated tube 155 to prevent the fluid, including any vapors therefrom, from coming into contact with the sensor. In some examples, the physical barrier is a transparent material to allow the sensor signals to pass through as they are transmitted from the sensor and directed back (e.g., reflected) from the target surface. In some examples, the physical barrier is a lens that is configured to focus the sensor signals (e.g., optical signals) to a point on the sensor. Use of the sensor within a sealed control unit may provide advantages by the control unit completely enclosing the sensor and other electronics via the physical barrier to mitigate corrosion and other wear or damage caused by direct contact with the fluid within the container.

In some examples, the control unit may include a microprocessor (e.g., microcontroller, processor, computing device, etc.) that is programmed to carry out various processing functions for the level-sensing device, including operation the sensor and other circuitry to perform the fluid level measuring analysis, detection of errors, operation of wireless transceivers to provide data and/or status information to an external system, operate an indicator (e.g., light indicator to provide notifications via various colors or flashing patterns, an audio device to provide aural notifications, etc.) to provide status or error indications. The control unit may be communicatively coupled to the devices disclosed herein via a wired or wireless connection. The wireless communication may be conducted from using Wi-Fi, BlueTooth®, or other wireless communication technologies. The communication of data with the external system may include, aside from a level indication and status/error messages, tank identification, date and time stamps, temperature information, etc. The data may be transmitted to a computing device via the Internet to allow offsite reference of the state of the level-sensing device and a measured level of the viscous or liquid chemical. The computing device may use the data to generate reports and analysis of the data, such as usage, costs, at regular intervals and generate alerts therefrom for leaks, low/high drum liquid levels, under/over usages of the anomalies in liquid level changes, and other conditions needing attention.

In some examples, the control unit may further include a motion or orientation sensing device to detect whether the level sensing device has moved and/or the orientation of the level sensing device. For example, the motion or orientation sensing device may detect when the level sensing device is moved as it is inserted into or removed from the storage container. This movement can be indicative of a process of changing the storage container or filling of the storage container. The motion or orientation sensing device may detect whether the level sensing device has been laid down mostly horizontally for an extended period of time. In some examples, this may be used to alert operators that the level sensing device is not properly installed. In some examples, the motion or orientation sensing device may provide an indication to the microprocessor of a vertical orientation of the level sensing device. The microprocessor may use the vertical orientation information to analyze a fluid level in the storage container. For example, if the motion or orientation sensing device indicates that the level sensing device is offset from a vertical position by a certain angle, the microprocessor may adjust a detected level of the storage container based on the certain angle to provide a more accurate detected fluid level. In some examples, the motion or orientation sensing device may also detect a rapid acceleration or movement of the level sensing device, which may cause the microprocessor to alert operators. The motion or orientation sensing device may be a multi-axis accelerometer, a gyro, or any combination thereof.

In some examples, the control unit may further include the indicator to provide notice of a status of the level sensor. For example, the indicator may include a light capable of emitting various colors and/or flash patterns to provide various status notifications, such as general fill levels of the storage container, an empty indication, detected faults or errors with the level sensor device (e.g., a disconnected level sensor, a defective level sensor, a sensor out of the drum, and a contaminated sensor or target surface, etc. The indicator may be a LED configured to illuminate in different colors based on a status of the level sensor, such as a first color (e.g., red) when the level sensor determines the storage container, e.g., barrel B, is empty or at a low level, a second color (e.g., yellow) when the level sensor determines a different, less critical, level of the contents of the storage container, and a third color (e.g., green) when the level is high. In addition, the same or different colors may illuminate based other status determination by the sensor, such as the previously described faults or errors. In a particular example, the LED may illuminate in a flash pattern or a color that differs from colors assigned to the sensed levels to indicate such faults or errors. Further, each fault or error may be assigned its own color or flash pattern.

In some examples, the described level-sensing device may be used in automatic car wash systems and in agricultural operations (e.g., indoor growing operations) to provide a way to monitor levels of car wash soaps and other chemicals used during a car wash process or to monitor levels of agricultural chemicals used during agricultural operations.

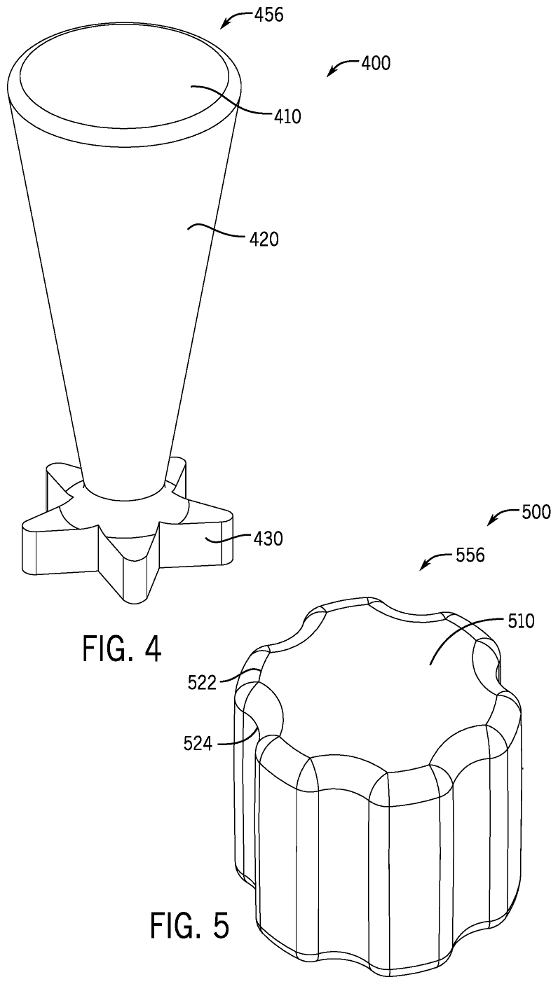

FIG. 4 is a side, isometric view 400 of an example of a float device 456, according to embodiments of the disclosure. The insert assemblies 100(1)-(4), the sensor assemblies 150, 350(1)-(4), and the float device 156 of FIG. 2B may implement the float device 456, in some examples. The float device 456 may include a target surface 410, a body 420, and a base 430 and be configured to be received in the elongated tube 155.

The body 420 formed on a top face of the float device 456 may have a surface area that is based a surface area of the top surface of the viscous or liquid chemical formed by inside walls of the elongated tube 155 in which it is to be installed. An outer-most diameter of the target surface 410 of the float device 456 may be slightly less than an inner diameter of the elongated tube 155 such that the float device 456 is free to move vertically within the elongated tube 155 as the level of the viscous or liquid chemical changes, while also providing a large target surface for the sensor. In some examples, the target surface 410 may consume the entire top face of the float device 456. In other examples, the float device 456 may include a bevel between the target surface 410 and the body 420.

The float device 456 may have a center of buoyancy and a center of gravity that maintains the target surface 410 in an upward-facing direction. In some examples, the float device 456 may include other features to hold the target surface substantially perpendicular to the direction of the signals transmitted from the sensor when titled at a slight angle. For example, the body 420 of the float device 456 may be a conical shape starting with a larger radius at the target surface 410 to a smaller area next to the base 430. The base 430 of the float device 456 may have a sufficient size and mass to maintain the center of buoyancy to maintain the target surface 410 in an upward-facing direction. In some examples, the base 430 may have a star-like shape, with an outer-most radius formed by the star being slightly smaller than the radius of the target surface 410. In some examples, the axial length of the float device 456 is greater than a radius of the target surface 410.

FIG. 5 is a side, isometric view 500 of a second example of a float device 556, according to embodiments of the disclosure. The insert assemblies 100(1)-(4), the sensor assemblies 150, 350(1)-(4), the float device 156 of FIG. 2B, and float device 456 of FIG. 4 may implement the float device 556, in some examples. The float device 556 may include a target surface 510 with a splined design with sidewalls having alternating splines or ribs 522 and grooves 524.

The target surface 510 of the float device 556 may have a surface area that is based on a surface area of the inside cross section of an elongated tube 155 in which it is to be installed. An outer-most diameter of the float device 556 (e.g., formed by the splines 522) may be slightly less than an inner diameter of the elongated tube 155 such that the float device 556 is free to move vertically within the elongated tube 155 as the level of the viscous or liquid chemical changes, while also providing a large target surface for the sensor. The splined design may improve fluid movement of the float device 556 within the elongated tube 155 by reducing surface area along the sides potentially in contact with sidewalls of the elongated tube 155 (e.g., as compared with a purely cylindrical design). In examples, the float device 556 may include a bevel or rounded edge between the target surface 510 and the ribs 522 and grooves 524.

Along with an outermost the diameter of the float device 556 being only slightly smaller than the inside diameter of the elongated tube 155, the float device 556 may have a center of buoyancy and a center of gravity that maintains the target surface 510 in an upward-facing direction.

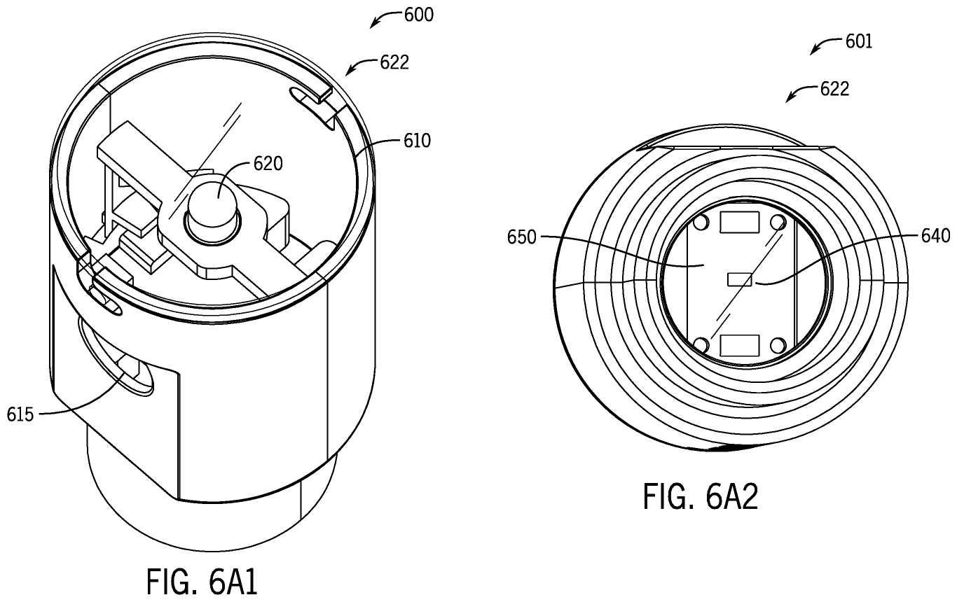

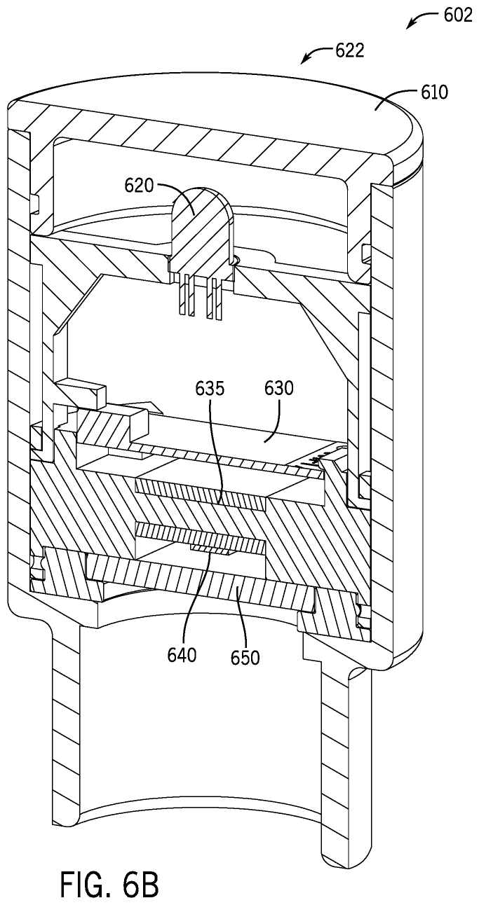

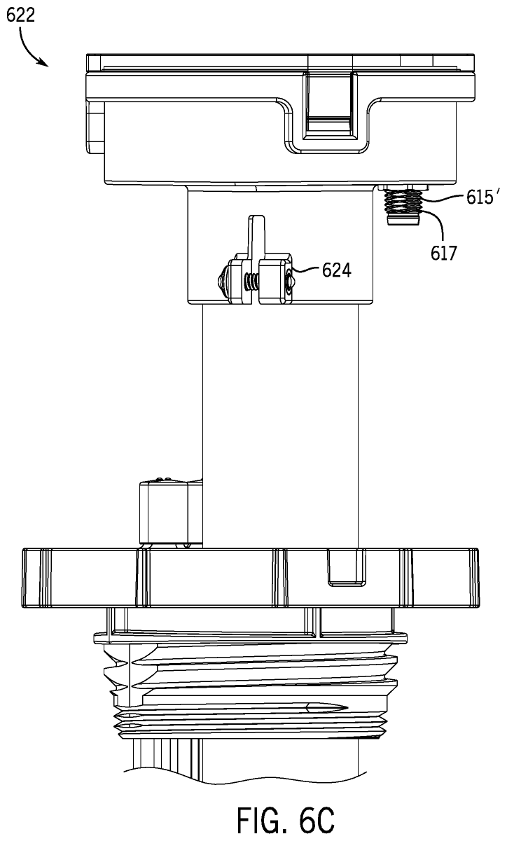

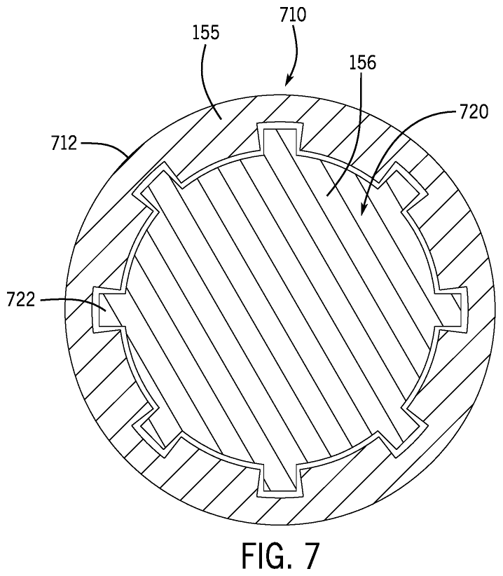

FIGS. 6A1, 6A2 and 6B depict various views of a control unit 622 of a level-sensing device, according to embodiments of the disclosure. The level sensing devices 350(1)-(4) of FIG. 3 and/or the control unit 152 of FIG. 2C may implement the control unit 622, in some examples. View 600 of FIG. 6A1 is an isometric top view of the control unit 622, view 601 of FIG. 6A2 is an isometric bottom view of the control unit 622, and view 602 of FIG. 6B is a cross-sectional view of the control unit 622.

The control unit 622 may include a top lens 610, a power port 615 to receive external power, an indicator 620, a microprocessor 630, a motion or orientation sensing device 635, a sensor 640, and a physical barrier 650. An outer housing of the control unit 622 may form a sealed enclosure containing the sensor 640. The power port 615 may be configured to receive external low voltage power to power the control unit 622. The control unit 622 may include a physical barrier 650 between the sensor 640 and a bottom opening to prevent the fluid from the container, including any vapors therefrom, from coming into contact with the sensor 640. In some examples, the physical barrier 650 is a transparent material to allow the sensor signals (e.g., optical or sound signals) to pass through as they are transmitted from the sensor 640 and return (e.g., reflected back) from the target surface of the float device. In some examples, the physical barrier 650 is a lens that is configured to focus the sensor signals to a point on the sensor 640. Use of the sensor 640 within a sealed control unit may provide advantages by the control unit completely enclosing the sensor and other electronics via the physical barrier 650 to mitigate corrosion and other wear or damage caused by direct contact with the fluid within the container.

In some examples, the sensor 640 may be an optical time-of-flight sensor, an ultrasonic sensor, a capacitive sensor, a radar, and/or a pressure transducer sensor. An optical time-of-flight sensor 640 of an optical time-of-flight level-sensing device 350(1)-350(4) may be configured to emit optical signals and to determine a time for those signals to be reflected back from the target surface of the float device 156 or from a top surface of a liquid contained within the elongated tube 155. Such optical signals may be emitted through a protective lens. Based on the return time, the optical level-sensing device may calculate a current level of the viscous or liquid chemical within the storage container. An ultrasonic sensor 640 of an ultrasonic level-sensing device 350(1)-350(4) may be configured to measure a distance by emitting ultrasonic waves and sensing the ultrasonic wave when it is reflected back from the target, e.g., from the target surface of the float device 156 or from a top surface of a liquid contained within the elongated tube 155. The ultrasonic sensor may measure the distance to the target by measuring the time between the emission and reception of the ultrasonic wave. A capacitive sensor 640 of a capacitive level-sensing device 350(1)-350(4) may be configured to detect a capacitance change of a capacitor. For instance a probe and the elongated tube 155 may form a capacitor, which capacitance is dependent on an amount fluid in the elongated tube. The sensor may detect a change in fluid level within the elongated tube by detecting a change in capacitance, where for instance a low fluid level has a lower capacitance while a higher fluid level has a higher capacitance. A radar sensor 640 of a radar level-sensing device 350(1)-350(4) may be configured to emit a high frequency RF pulse from an antenna, and the pulse travels through the elongated tube (e.g., through an air gap) reflects against the target, e.g., the target surface of the float device or of a top surface of the fluid in the elongated tube 155, and returns to the antenna. The fluid level may be determined by the radar pulse time of flight, which may be converted in to a level height or distance. A pressure transducer sensor 640 of a pressure transducer level-sensing device 350(1)-350(4) may be configured to be arranged at a distal end of the elongated tube 155, e.g., may be coupled to the cap 157, and be submerged in the fluid contained in the elongated tube 155. The pressure transducer sensor 640 may be configured to measure hydrostatic pressure to detect a depth of fluid within the elongated tube 155, and the sensor signals may be used to determine a change in fluid level in the elongated tube 155. Accordingly, the sensors 640 may detect a fluid level or a change in fluid level in the elongated tube, which may be used by the level-sensing device 350(1)-350(4) and components communicatively coupled thereto to for instance determine whether operational parameters of the fluid management components fluidly coupled to the insert assembly 100 should be modified and/or if the storage containers 310(1)-310(4) should be replaced or the fluid therein be replenished.

In some examples, the microprocessor 630 (e.g., microcontroller, processor, computing device, etc.) may be programmed to carry out various processing functions for an level-sensing device, including operation the sensor 640 and other circuitry to perform the liquid level measuring analysis, detection of errors, operation of wireless transceivers to provide data and/or status information to an external system, operate the indicator 620 (e.g., cause the light indicator to provide notifications via emission of various colors or flashing patterns) to provide status or error indications. The wireless communication may be conducted from using Wi-Fi, BlueTooth©, or other wireless communication technologies. The communication of data with the external system may include, aside from a level indication and status/error messages, tank identification, date and time stamps, temperature information, etc. The data may be transmitted to a computing device via the Internet to allow offsite reference of the state of the level-sensing device and a measured level of the viscous or liquid chemical. The computing device may use the data to generate reports and analysis of the data, such as usage, costs, at regular intervals and generate alerts therefrom for leaks, low/high drum liquid levels, under/over usages of the anomalies in liquid level changes, and other conditions needing attention.

In some examples, the motion or orientation sensing device 635 may detect whether the level sensing device has moved and/or the orientation of the level sensing device has changed. For example, the motion or orientation sensing device 635 may detect when the level sensing device is moved as it is inserted into or removed from the storage container. This movement can be indicative of a process of changing the storage container or filling of the storage container. The motion or orientation sensing device 635 may detect whether the level sensing device has been laid down mostly horizontally for an extended period of time. In some examples, this may be used to alert operators that the level sensing device is not properly installed. In some examples, the motion or orientation sensing device 635 may provide an indication to the microprocessor of a vertical orientation of the level sensing device. The microprocessor may use the vertical orientation information to analyze a fluid level in the storage container. For example, if the motion or orientation sensing device 635 indicates that the level sensing device is offset from a vertical position by a certain angle, the microprocessor may adjust a detected level of the storage container based on the certain angle to provide a more accurate detected fluid level. In some examples, the motion or orientation sensing device 635 may also detect a rapid acceleration or movement of the level sensing device, which may cause the microprocessor to alert operators. In some examples, the motion or orientation sensing device 635 may be configured to accept physical interaction as human-machine interface (HMI). This may enable HMI functionality to exist while allowing the control unit 622 to be completely sealed and protected. For instance, a user may touch, tap or otherwise provide haptic input to the control unit 622, which may be sensed by the motion or orientation sensing device 635 and the microprocessor may determine the user is signaling that the storage container has been refilled or replaced. The motion or orientation sensing device 635 may be a multi-axis accelerometer, a gyro, or any combination thereof.

In some examples, the indicator 620 may be visible through the top lens 610 and may provide notice of a status of the level sensor. The indicator 620 may include a light capable of emitting various colors and/or flash patterns to provide various status notifications, such as general fill levels of the storage container, an empty indication, detected faults or errors with the level sensor device (e.g., a disconnected level sensor, a defective level sensor, a sensor out of the drum, and a contaminated sensor or target surface, etc.

FIG. 6C depicts the control unit 622 of a level-sensing device, according to variants of the disclosure. The components of the control unit 622 of FIG. 6C are substantially similar to those described in connection with FIGS. 6A and 6B and are not repeated in the interest of brevity. FIG. 6C illustrates the housing of the control unit 622 with a power port 615′ configured with a threaded connector 617 extending from a lower portion of the housing of the control unit 622. Although the power port 615′ is illustrated with a threaded connector 617, the connector may include any engagement mechanism for coupling with a power source such as quick connections including compression or twist style engagement mechanisms, z-thread or quarter turn engagement mechanisms, snap detent mechanisms, clamp assemblies, and the like. The outer housing of the control unit 622 may be coupled to the elongated tube by a coupling device 624, for instance configured as a releasable clamp or a cam lock, e.g., clamping handle coupled to a split ring or clamp for establishing a pinch, compression, and/or friction lock.

The internal cross section of the elongated tube 155 described herein may take various shapes without departing from the scope of the disclosure. In some examples, the elongated tube may have an internal cross-section adapted to receive the float device (e.g., the float device 156 of FIG. 2C, the float device 456 of FIG. 4, and/or the float device 556 of FIG. 5), where the float device may take one of various configurations and thus one of various external cross-sections. For instance, the elongated tube 155 may have a circular internal cross-section, while the float device may have any one of a circular, oval, square, triangular, multi-point or faceted (e.g. 5-, 6-, 7-, or 8-point star or facet (e.g., scallop or square-shape protrusion)) external cross-section. In some examples, the elongated tube may have an internal cross-section complementary to the external cross-section of float device. For example, the elongated tube and float device may each have the same of any of the aforementioned cross-sections. In such implementations, the float device may be guided by the corresponding internal cross-section of the elongated tube as the level of the fluid in the storage container changes, and for instance the float device may be prevented from rotating or tilting, or may be prevented from rotating or tilting by more than a pre-defined angle, due to the complementary cross-sections.

The complementary shape of the cross-sections may be the result of one or more structural features extending along all or a portion of the length of the elongated tube 155. For instance as shown in FIG. 7, the cross-section 710 of the elongated tube 155 may contain elongated grooves 712 along an internal sidewall thereof, while the cross-section 720 of the float device, e.g., float device 156 may include external ribs 722 configured to be received by the longitudinally extending grooves 712. The grooves 712 and ribs 722 may have any shape and for instance may have a V-shape, square, square with rounded edges, and so on. To further this example, one or more secondary structural feature may be incorporated into the elongated tube that causes the float device to rotate about a central axis of the float device or that causes the float device change position such as tilt. Such secondary structural features may be arranged at predetermined points along the longitudinal length of the elongated tube. For instance, where the elongated tube includes one or more longitudinally extending internal grooves 712, the secondary feature may be the one or groove extending circumferentially by about 10 to 90 degrees to form a thread-like portion that causes the ribs 722 of the float device to rotate by a corresponding amount as the float device travels along the elongated tube. In another example, some of the longitudinally extending internal grooves 712 may widen while opposing grooves 712 may taper to cause the float device to be urged towards the tapering grooves (e.g., to translate) within the elongated tube by a predetermine amount upon reaching the secondary feature. The system may be pre-programmed to detect a change in position of the float device as a result of movement along the secondary structural feature(s). For instance, where the float device may rotate by 10 to 90 degrees as the float device translates down the elongated tube upon reaching a thread-like secondary structural feature, this may result in the system determining or confirming that a remaining level of fluid in the container is at a pre-defined amount, such as 10-50 percent.

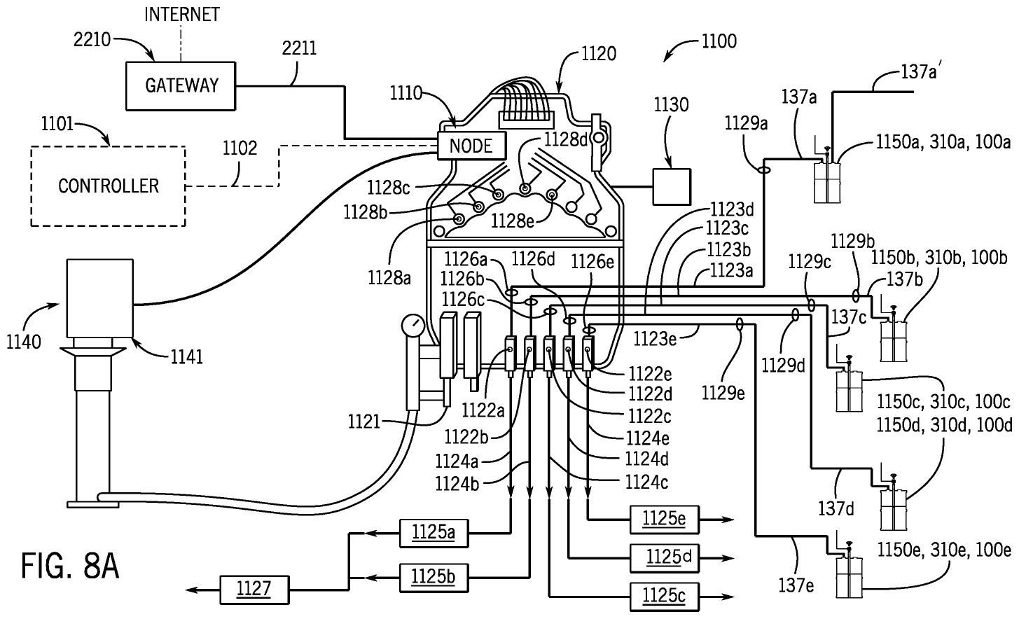

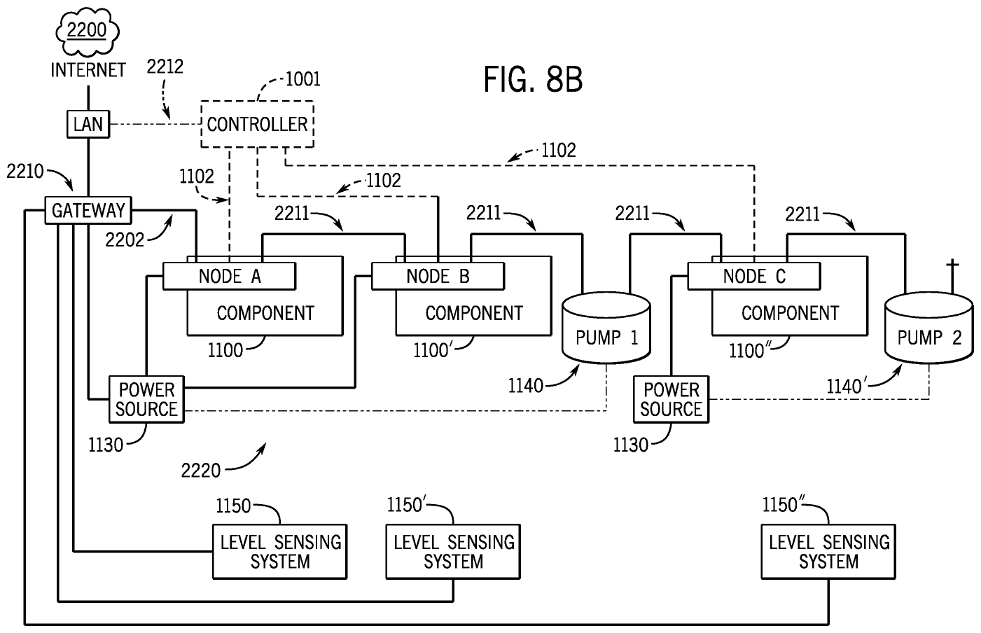

Turning to FIG. 8A, illustrated is a dilution control system 1100 that may be integrated with the insert assembly 100, the sensor assembly 150, and/or the level-sensing devices 350(1)-(4), according to the present disclosure. For example, in FIG. 8A, individual reservoir and level sensing systems 1150a-1150e are fluidly coupled to the solution delivery system 1120. The individual reservoir and level sensing systems 1150a-1150e may be integrated into the insert assemblies 100a-100e of the present disclosure. More specifically, the solutions contained in the storage containers 310(1)-(4) of FIG. 3 shown as 310a, 310b, 310c, 310d, 310e in FIG. 8A may be fluidly coupled to the solution supply lines 1123a-1123e for use in distributing the solutions, e.g., as a mixed solution of chemical and water, via the dilution control system 1100. In some examples, as the level of solution changes in the storage containers 310a-e, this information can be sensed by the respective level sensing system level sensing systems 1150a-1150e, which may be integrated with the insert assemblies 100a-100e, and the sensed information may be transmitted to the dilution control system 1100. In such examples, the dilution control system 1100 may interpret the received information and may generate control signals based thereon.

Insert assembly 100a is illustrated as including two first fluid lines 137a, 137a′ exiting the container 310a via the fluid distribution mechanism 130 with the first fluid line 137a fluidly coupling to the dilution control system 1100 and the other first fluid line 137a′ fluidly connecting to a different fluid distribution destination. According to the present disclosure, more or less than two first fluid lines may exit the fluid distribution mechanism 130 of the insert assembly 100a. Similarly, although the other insert assemblies 100b, 100c, 100d, 100e are illustrated as being fluidly coupled to a single dilution control system 1100, it will be understood that the insert assemblies 100b-100e and their respective storage containers 310b-310e may each be fluidly coupled via multiple first fluid lines to a plurality of fluid distribution destinations including other dilution control systems.

With respect to the dilution control system 1100, this may include a processor 1110, a solution delivery system 1120 for mixing solutions (e.g., concentrated chemicals) with motive fluid to form one or more mixed solutions, and a power source 1130. The dilution control system 1100 may optionally include a pump 1140. Each of these may be housed within the same location where solutions are diluted in motive fluid (e.g., pumped water). As illustrated in FIG. 8A, the dilution control system 1100 may include the processor 1110 and solution delivery system 1120 integrated into a single assembly, and may include inputs for a connector 1102, the power source 1130, and connection 1211.

The dilution control system 1100 may be configured to monitor and control dilution operations by receiving signals from the processor 1110, from the level-sensing device and its control unit of the present disclosure, e.g., sensor assembly 150, level-sensing devices 350(1)-(4) and their corresponding control units, from an optional external controller 1101, also referred to as a customary car wash controller, at the same location as the dilution control system 1100, or from combinations thereof. In response to receiving the signals, the processor 1110 of the dilution control system 1100 may interpret the signals and instruct the dilution control system 1100 to operate, such as by adjusting a rate of delivery of solutions from the solution delivery system 1120. The dilution control system 1100 may be operated via the processor 1110 and the power source 1130 of the dilution control system 1100, both of which may be separate from the optional external controller 1101 and the optical level-sensing device and any related components, e.g., separate from power and memory of such external devices. This may enable the processor 1110 to control when and if the dilution control system 1100 will operate upon receiving the signals from these external devices. Similarly, while the level-sensing device may transmit and receive information to the processor 1110 or other external devices, the control unit of the level-sensing device may control when and if the system will operate upon receiving signals from these external devices. For example, where the external controller 1101 might typically control some operations of the level-sensing device or a solution delivery system 1120, each of the presently disclosed level-sensing devices (e.g., 350(1)-(4), 150) and the dilution control system 1100 may instead control their respective operations by overriding signals sent by the external controller 1101, resulting in their operation at different operating parameters from those sent by the external controller 1101 or other device. In this example, some components of the optical level-sensing device and/or the solution delivery system 1120 may be a legacy component of a pre-existing device or system operated by the external controller 1101, also known as a customary car wash controller of the legacy component.

According to the present disclosure, the processor 1110 of the dilution control system 1100 may use onboard memory and programming for controlling the dilution control system 1100. The processor 1110 may be communicatively coupled to the solution delivery system 1120, the power source 1130, the pump 1140, the level-sensing device (e.g. 350(1)-(4), 150), the external controller 1101, as well as other system and network components of the present disclosure; and may be configured to send and receive signals to and from these communicatively coupled components. The processor 1110 may be configured, for instance, as a microcontroller or a computer processor depending processing requirements for operating the dilution control system 1100. The processor 1110 may generate control signals to, for instance, cause the power source 1130 to power on/off the dilution control system 1100 and cause the solution delivery system 1120 to cause solutions (e.g., concentrated chemicals) and motive fluid to be mixed according to a target dilution rate. In some cases, the processor 1110 may instruct the dilution control system 1100 to be powered at a voltage independent of a sensed voltage from the external controller 1101 such that the dilution control system 1110 is not capable of converting voltage received from the external controller 1101 into a different voltage for operation of electrical components coupled to the solution delivery system 1120. However, the dilution control system 1100 may include a voltage converter that takes a standard input (e.g., 24 VDC) for valve actuation and converts to a different voltage (e.g., 5 VDC) for the processor 1110, but such a converter may not be present at an interface between the dilution control system 1100 and the external controller 1101. The control units of the present disclosure (e.g., 152, 622) may be configured the same as the processor 1110 described herein, for instance, to receive input from such external devices and generate its own control signals for operation of the level sensing device, for instance, such that the control units cause the level-sensing device to operate at different parameters compared to those sent by the external device(s).

The processor 1110 may be powered via a communications link, such as a link from network components at the setting housing the dilution control system 1100. For instance, the processor 110 may be coupled via a serial communication cable to a network component and may be powered therefrom. In addition or alternatively, the processor 1110 may be powered from another power source, for instance, depending upon the need for connection of sensors or actuators and their power demand. In some implementations, the processor 1110 is powered from the power source 1130.

The solution delivery system 1120 of the dilution control system 1100 may be configured to facilitate fluid distribution, e.g., solution, motive fluid and mixed solution distribution, and mixing of solution and motive fluid to form the mixed solution, in response to receiving control signals from the processor 1110. The solution delivery system 1120 may be configured with actuators that control valves, and the processor 1110 may be referred to as a valve node. The valve(s) may be coupled to one or more fluid chambers configured to mix a solution (e.g., a solution from the solution tank 310a-310e or other concentrated chemical) and water in a mixed solution in which the solution is diluted, and distribute the mixed solution. For instance, the dilution control system 1100 may include one or more solenoid valves, each operatively connected to a fluid chamber. By controlling an on/off status of the solenoid valve(s), fluid flow may be controlled through the fluid chamber(s). In FIG. 8A, upon operation of individual actuators such as solenoid valves 1128a-1128e, motive fluid from a motive fluid inlet 1121 of the solution delivery system 1120 may deliver motive fluid to corresponding motive fluid inlets of one or more fluid chambers 1122a-1122e fluidly coupled to solution supply lines 1123a-1123e via solution inlets of the fluid chambers 1122a-1122e, and the motive fluid may mix with each of the respective solutions in their respective fluid chambers 1122a-1122e. The mixed solutions may each exit a mixed solution outlet 1124a-1124e of each of the respective fluid chambers 1122a-1122e. The solution delivery system 1120 may be configured as a bank of valves and injectors in a dispensing panel that may be responsible for distributing mixed solutions from a plurality of fluid chambers coupled to the bank of actuators in response to receiving control signals from the processor 1110 of the dilution control system 1100. Injectors (such as venturi injectors, also known as eductors) may house the fluid chambers 1122a-1122e and may define the mixed solution outlets 1124a-1124e, which may lead to one or more application areas where the mixed solution is applied or where the mixed solution is further mixed with other motive fluid, solutions, or mixed solution(s).

In some implementations, the fluid chambers 1122a-1122e each may be coupled to individual solution supply lines 1123a-1123e via individual metering devices 1126a-126e. The individual solution supply lines 1123a-1123e may be fluidly coupled to a respective individual reservoir 310a-310e and level sensing system 1150a-1150e integrated into the insert assemblies 100a-100e of the present disclosure. The metering devices 1126a-1126e may include, for example, a solution inlet of a fluid chamber with an adjustable orifice supplying the solution to the solution inlet. The orifice opening may be adjusted to reach the target level of the solution. For example, the orifice may be widened or narrowed to permit more or less solution into the solution inlet of the fluid chamber to adjust a metering rate of the solution, such as using a pinch valve. In addition or alternatively, the metering devices 1126a-1126e may include a positive displacement pump such as a peristaltic pump that may positively displace fluid over an impingement path, and the rate of fluid displacement may be adjusted to increase or decrease a rate of solution delivery from the tube. Adjusting the rate of displacement may be through adjusting a rotation rate of one or more rollers of the peristaltic pump. Accordingly, in this example, the peristaltic pump may be configured to impinge on a solution delivery tube where a rate of displacement of the solution from the solution delivery tube may be adjusted to change a metering rate of the solution.

Chemical delivery systems that include actuators and eductors also known as venturi injectors are disclosed in U.S. Pat. No. 8,887,743 B2, the disclosure of which is incorporated herein by reference for any useful purpose. Chemical injectors may include a motive fluid inlet, a chemical inlet and a mixed solution outlet and may operate to draw in concentrated chemical (e.g., a solution from one or more storage containers) into a mixing chamber upon delivery of a motive fluid into the mixing chamber, which creates a vacuum pressure in the mixing chamber to thereby draw in the concentrated chemical(s). The metered amount of concentrated chemical drawn into the mixing chamber may be adjusted by adjusting a cross-sectional size of the flow path through which the chemical passes, which may adjust a flow rate of the chemical to thereby adjust a dilution rate. In addition or alternatively, the mixing chamber or chemical injector may receive concentrated chemical via a positive displacement pump. In some implementations, the motive fluid may be delivered via a common motive fluid supply, such as via a delivery manifold with a motive fluid inlet and a plurality of outlets each coupled to an injector. Manifolds for receiving and distributing motive fluid are also disclosed in U.S. Pat. No. 8,887,743 B2.

Implementations where a metering device is configured to adjust a cross-sectional size of the flow path through which the concentrated chemical passes and which may be coupled to the chemical delivery system 1120 at the solution inlets of the mixing chambers, injectors or other mixing devices, are disclosed in US 2019/0022607 A1, the disclosure of which is incorporated herein by reference for any useful purpose.

While the rate of distribution of solutions at the mixing devices, e.g., injectors, may be controlled by means such as controlling the size of a solution outlet port leading to the solution injector (e.g., including fluid chambers 1122a-1122e), controlling the size of the solution inlet port of the solution injector, controlling a metering rate of a pump, and so on, the intended or target rate of solution distribution may differ from the actual rate of distribution (e.g., due to the size of the outlet port being too large or too small for the intended rate of distribution) resulting in a mixed solution having a dilution rate that is off-target. Accordingly, the dilution control systems 1100 of the present disclosure optionally include one or more sensors for sensing tracer components optionally present in the mixed solution at or upon exiting the mixed solution outlet 1124a-1124e fluidly coupled to the fluid chamber 1122a-1122e. The optional tracer components may be components having detectable properties present in the solution supply, e.g., within the storage tanks 210, and may be pre-existing components of the solution or may be added thereto. These may be active or inactive components relative to the function of the solution. Once the mixed solution is formed and/or distributed from the mixed solution outlet, e.g., one or more of mixed solution outlets 1124a-1124e, and before the mixed solution is further mixed or applied to a target, a sensor such as sensors 1125a-1125e may sense a level of a tracer component in the mixed solution and may determine a dilution rate of the solution in the mixed solution, or the sensed information may be sent to the processor 1110 for determining the dilution rate.

As shown in FIG. 8A, the housings of each of the sensors 1125a-1125e may be coupled to fluid lines fluidly coupled to corresponding mixed solution outlets 1124a-1124e on a one-to-one basis such that each sensor may sense a tracer in the mixed solution of a mixture of a single solution with its tracer component and the motive fluid. The sensors 1125a-1125e may each be configured to sense one or more tracer components. For instance, the sensors 1125a-1125e may be configured to sense the same tracer component as the other sensors, or may be configured to sense a tracer component that differs from the tracer components sensed by other tracer components. In addition or alternatively, each of the sensors 1125a-1125e may be configured to sense different levels, e.g., discrete ranges, of the tracer component compared to the other sensors. In this way, solutions containing a specific tracer component or a specific level of tracer component may be fluidly coupled to the fluid chamber, e.g., 1122a-1122e, having the corresponding downstream sensor, e.g., 1125a-1125e, for sensing the tracer component or range of tracer component contained therein.

The sensors 1125a-1125e may be configured to sense properties such electrical conductivity, total dissolved solids (TDS), salinity, pH, dissolved oxygen, color, and the tracer component may be a corresponding component having such properties that are capable of being sensed by the sensor. Thus, the sensors 1125a-1125e may be electrical conductivity sensors, TDS sensors, salinity sensors, pH sensors, oxygen sensors, spectral analysis sensors, and combinations thereof.

Further, the sensors 1125a-125e may be communicatively coupled to the dilution control system 1100 such as the processor 1110, to a communications gateway 1210, or other networked components, and such communicative coupling may be wired or wireless according to the various communication modes disclosed herein.

Separate from the sensors 1125a-1125e, implementations may further include one or more additional sensors 1127 downstream of the sensors 1125a-1125e for use in sensing combinations of mixed solutions, such as a combination of mixed solutions from mixed solution outlets 124a and 124b. The one or more additional sensors 1127 may be configured to sense the same or a different tracer component from the tracer components sensed by sensors 1125a and 1125b. The additional sensors may be used to determine that the combination of mixed solutions is present in a target amount, and may be communicatively coupled to the dilution control system 1100 in the same manner as the sensors 1125a-1125e to enable the dilution control system 1100 to adjust a level of one or more of the solutions dispensed in the combined mixed solution.

While the dilution control system 1100 may adjust the metering device and/or the motive fluid delivery rate to reach a target dilution rate for later produced mixed solutions, the dilution control system 1100 may be further configured to manipulate the dilution of existing analyzed mixed solutions to reach a target dilution rate. For instance, water may be added to the existing and analyzed mixed solutions when under-diluted, or by adding solution or a more concentrated mixed solutions when over-diluted. This approach may enable the dilution of an existing amount of the mixed solution, e.g., a batch of the mixed solution, to be adjusted to reach a target dilution rate before being delivered to downstream locations.

Further details of the dilution control system 1100 are disclosed in U.S. patent application Ser. No. 17/976,147, filed on Oct. 28, 2022 and entitled “SYSTEMS AND METHODS FOR MONITORING AND CONTROLLING DILUTION RATES”, the disclosure of which is incorporated herein by reference for any useful purpose.

In addition or as an alternative to the sensors 1125a-1125e, the dilution control system 1100 may include flow rate sensors 1129a-1129e configured to sense a flow rate of each of a respective fluids within respective in-feed lines, e.g., first fluid lines 137a-137e prior to the fluid or concentrated chemical reaching the fluid chambers 1122a-1122e and mixing with a motive fluid such as pressurized water, delivered via the which pressurized motive fluid may enter via the fluid inlet 1121 of the dilution control system 1100. The flow rate sensors 1129a-1129e may be coupled to the in-feed lines via a coupler such as a clamp, and may be positioned upstream or downstream of the metering devices 1126a-1126e. The flow rate sensors 1129a-1129e may be configured as ultrasonic flow meters that use sound waves to detect a velocity of fluid flowing through the in-feed lines 130-138 to determine a volumetric flow therethrough.

Associating each of the flow rate sensors 1129a-1129e with a respective concentrated chemical in-feed line may enable precise amounts of the fluid from the containers 310a-310e to be dispensed into the dilution control system 1100 as provided herein. This provides advantages over systems that do not include a flow rate sensor in combination with metering devices 1126a-1126e, particularly because while metering devices typically dispense product at rates determined by a manufacturer's lab data, there is no way to confirm the actual delivery rates of the metering device once installed. More particularly, the flow rate sensors 1129a-1129e may be communicatively coupled to respective metering devices 1126a-1126e either directly or via devices such as the gateway 2210 or other control unit, e.g., control unit 152, control unit 622, the processor 1110, and based on the flow rate information, one or more of the metering devices 1126a-1126e may adjust a rate of dispensing of one or more of the fluids to thereby control the flow rates of the fluids, such that a dilution of each of the fluids in the motive fluid can be individually controlled in real-time. In some cases, a communicatively coupled device may receive data from one or more of the flow rate sensors 1129a-1129e corresponding to an actual flow rate, and when the device determines a target flow rate differs from an actual flow rate, the communicatively coupled device causes a corresponding metering device, e.g., metering device 1126a, to adjust its rate of dispensing of its corresponding fluid, e.g., fluid within container 310a, into the fluid chamber 1122a. For instance, when the metering device 1126a is a pinch valve or a needle valve, an orifice size of the first fluid line 137a may be caused to be adjusted, e.g., larger or smaller, upon determining the target flow rate differs from the actual flow rate, to thereby adjust the amount of concentrated chemical delivered to the fluid chamber 1122a. In some examples, in response to receiving the measured flow rate from each flow rate sensor, the communicatively coupled device may additionally or alternatively adjust the control signal for operating a valve 1128a of the solution delivery system 1120 coupled to the motive fluid inlet of the fluid chamber 1122a.

In further implementations, the sensors 1125a-1125e may alternatively be configured as flow rate sensors and may measure a flow rate of the mixed solution passing through the mixed solution lines exiting the mixed solution outlets 1124a-1124e. In addition or alternatively, the additional sensors 1127 downstream of multiple mixed solution outlets may measure the total outlet flow from such mixed solution outlets, e.g., from mixed solution outlets 1124a and 1124b.

The solution delivery system 1120 may be configured to additionally include: pumps, motors (e.g., stepper motors), sensors (e.g., thermometers, cameras), heating elements, servo actuators, or another actuator that requires electric control.

In certain implementations, the processor 1110 may receive signals from the dilution control system 1100, e.g., indicating an operational status the solution delivery system 1120, the sensors 1125a-1125e, as well as signals and information from other communicatively coupled components such as other dilution control systems (e.g., 1100′), actuators, motors, variable frequency drives, pumps and valves, sensors, a communications gateway with in the setting housing the dilution control system 1100, and from network components outside of the setting housing the dilution control system 1100, for use in controlling the solution delivery system 1120. For instance, the processor 1110 may be programmed to sense or receive information about power to the overall system, power to the dilution control system 1100, connectivity to a network, the number of operations of the dilution control system 1100 (e.g., dispensing events, timing of dispensing events), solution (e.g., concentrated chemical) supply levels, dilution level, chemical conductivity, pH of a mixed solution, pH of a chemical, pH of water, temperature of the water, temperature of the solutions, ambient temperature, humidity, target to be treated, the location of the dilution control system (e.g., GPS components or arrangement within a setting), age, wear, or operational status, and a network identifier.

In one example, the number of cycles or duration a dilution control system 1100 has been in use may be determined by the processor 1110 and may provide reporting to the network components based thereon. The processor 1110 may be programmed to generate different control signals for operating the dilution control system 1100 using the gathered information. The processor 1110 may instruct motors or pumps to be powered on for a longer duration as the dilution control system 1100 ages in order to reduce wear on the component from frequent on/off cycles. Other examples may involve the processor 1110 generating control signals to adjust pump pressure, solution use, dilution ratios, and so on.

In some implementations, the solution delivery system 1120 may operate by a single control voltage, which may be 24 VDC, provided by the power source 1130. However, the solution delivery system 1120 may be configured to accept any common control voltage, e.g., 24 VAC, 24 VDC, or 120 VAC, ±20%, and so on, from the power source 1130. The power source 1130 may be integrated into the dilution control system 1100 or may be arranged separately within the confines location where the dilution control system 1100 is situated and may be configured as a breaker box or a battery, for example. The power source 1130 may be independent of any power source of the external controller 101, which provides autonomy to the dilution control system 1100.

An optional pump 1140 of the dilution control system 1100 may provide fluid pressure to the dilution control system 1100. The pump 1140 may be communicatively coupled to the processor 1110 and the power source 1130 and may be configured to deliver fluid pressure to operate the solution delivery system 1120 such as by pressurizing motive fluid for delivery to the solution delivery system, which pressurized motive fluid may enter via the fluid inlet 1121 or be pressurized by the pump 1140 at the fluid inlet 1121. For instance, upon receipt of power from the power source 1130 in response control signals from the processor 1110, the pump 1140 may deliver fluid pressure over a pre-determined timing cycle to a fluid input line of the solution delivery system 1120. The pump 1140 may provide water pressure to the dilution control system 1100, which may provide pressure assistance to a water supply, e.g., a municipal water supply, or may provide the sole source of pressure to the water input of the dilution control system 1100 and for instance may be responsible for delivering motive fluid to the motive fluid inlet 1121 of the solution delivery system 1120.

The pump 1140 may also provide pressure to a solution input of the dilution control system 1100, however, the solution input may alternatively rely on vacuum pressure for fluid delivery into the dilution control system 1100, for instance using venturi valves, which are disclosed in U.S. Pat. No. 8,887,743 B2. The pump 1140 may include a processor 1141 communicatively coupled to the processor 1110 of the dilution control system 1100 and operation of the pump 1140 may be controlled through communications between the processors 1110, 1141. As can be appreciated, in some implementations, the pump 1140 may be a dilution control system 1100 that cooperates with other dilution control systems, e.g., a second dilution control system 1100′, as described.

In some implementations, the processor 1110, the solution delivery system 1120, the power source 1130, and/or the pump 1140 may be housed within the dilution control system 1100, and may be integrated into the same dispensing panel. In a further example, the processor 1110 may be wired or wirelessly coupled to the dilution control system 1100. For instance, the processor 110 may be wired to multiple, individual actuators, all of which may be housed within a dispensing panel.

According to implementations of the present disclosure where an external controller 1101 controls distribution of solutions to the solution delivery system 1120 or where the external controller 1101 controls the solution delivery system 1120, the processor 1110 may receive a sensed voltage from the external controller 1101 to cause a level of solution to be delivered at a pre-determined setting to reach a target dilution rate, and the processor 1110 may instruct the solution delivery system 1120 of the dilution control system 1100 to be powered via the power source 1130 at a voltage independent of the sensed voltage. Where the actual dilution rate sensed by the sensor, e.g., sensor 1125a-1125e, differs from the target dilution rate, the processor 1110 of the dilution control system 1100 may override the external controller 1101 and cause the power source 1130 to operate the solution delivery system 1120 such that a level of the solution dispensed from the solution delivery system 1120 is adjusted, e.g., increased or decreased, to reach the target dilution level.

In such implementations where the dilution control system 1100 operates in combination with a customary external controller 1101, the external controller 1101 may be a customary power source that delivers timed voltage signals to multiple systems in the setting where the dilution control system 1100 is arranged, including solution delivery systems, and may typically deliver common control voltages of: 24 VAC, 24 VDC, or 120 VAC, ±20% to operate these multiple systems, including fluid management and dilution systems. However, the processor 1110 of the dilution control system 1100 may instead interpret the control voltage of the external controller 1101 simply as a signal (e.g., a sensed voltage), and instead of allowing the same signal to be relayed to the solution delivery system 1120 of the dilution control system 1100, the processor 1110 may interpret the signal (e.g., as a signal meant to perform some action or operation by the dilution control system 100), generate a different control signal and send this to the solution delivery system 1120 for dispensing solutions according to the commands of the dilution control system 1100. Thus, while the external controller 1101 may control the operation of other devices in this setting, the external controller 1101 may more simply deliver a signal to the dilution control system 1100 for subsequent interpretation by the processor 1110 and action. This configuration may provide the dilution control system 1100 autonomy relative to other devices that may be controlled in a customary manner by the external controller 1101. For instance, the external controller 1101 may be responsible for controlling air, water, solution dispensing, and/or coordinating other aspects related to fluid management and delivery by using programmable logic controller (PLC) or similar technology and may send signals to various components in the setting. These signals might be control voltages, analog signals, or digital signals. While the external controller 1101 may control a variety of different devices, the dilution control systems 1100 of the present disclosure are responsible for orchestrating their own operation due to their ability to interpret control signals received from the external controller 1101 and generate new control signals for operation of the dilution control system. A number of components may be controlled by the external controller 1101, while dilution control systems (e.g., 1100, 1100′, 1100″) provided according to the present disclosure, may operate independently from the external controller's 1101 commands.

In implementations where the processor 1110 is programmed to generate a separate signal from the external controller 1101, the dilution control system 1100 may be operated using different operating parameters relative to the parameters sent by the external controller 1101. The processor 1110 may be configured to receive control signals from the external controller 1101 and/or from the communications gateway 1210, and/or from other processors 1110 of other dilution control systems described herein, and based on a variety of information collected by the processor 1110, the processor may generate a new control signal and send to the solution delivery system 1120 of its dilution control system 1100 in a dedicated manner. For instance, the processor 1110 may be programmed to track operations of the dilution control system 1100 and generate control signals for operation of the dilution control system 1100 based thereon. The processor 1110 may query its communicatively coupled components for information that can affect the operating parameters of the dilution control system 1100 and may be used by the processor 1110 to configure the control signal using the received information. In some implementations, the processor 1110 may be configured to only receive commands from the external controller 1101 and/or the communications gateway 2210, and/or from other processors of other dilution control systems, but may not be configured to send instructions to these components.

Turning to FIG. 8B, the dilution control system 1100 that may be integrated with the level sensing systems 1150, 1150′, 1150″ and the insert assemblies 100a-100e (FIG. 8A), according to embodiments of the present disclosure. The control units of the level sensing systems 1150, 1150′, 1150″ may be communicatively coupled with a local communications gateway 2210, and the dilution control system 1100, also referred to as a component 1100 and a number of components 1100, 1100′, 1100″ may also be communicatively coupled to the local communications gateway 2210 for use in facilitating fluid delivery operations in a fluid delivery control system 2220 along with various components of the present disclosure. The components 1100′, 1100″ may for example be configured as dilution control systems including the components of the dilution control system 1100, as described, and/or as solenoid valves, pressure gauges, pumps, motors, sensors, heating elements, servo actuators, other actuators, and so on. The components 1100′, 1100″ may be fluidly coupled to a respective level sensing system 1150′, 1150″. As shown in FIG. 8B, the power source 1130 may provide power to the components of the fluid delivery control system 2220 and/or to the level sensing systems 1150, 1150′, 1150″ and optionally pumps 1140; however, the power source 1130 may be separate from any power source derived from the optional external controller 1101 to allow for the independent operation of the components of the fluid delivery control system 2220.

The communications gateway 2210 may be configured with a processor and be communicatively coupled to the level sensing systems 1150, 1150′, 1150″ and/or system components 1100, 1100′, 1100″ via connection 2211 (e.g., a serial connection) and the external controller 1101 via connection 2212. Each fluid delivery control system 2220 may include its own communications gateway 2210 and the gateway 2210 may be coupled to remote locations via the internet, as well as to other devices at the fluid delivery control system 2220 via the internet via a local area network (LAN) or other near range communication equivalents, e.g., Wi-Fi, Bluetooth® or LoRa, RFID, NFC, ANT, Zigbee, or WLAN, or via long range communication equivalents such as WAN. The communications gateway 2210 may troubleshoot or fix problems with the components 1100, 1100′, 1100″, 1150, 1150′, 1150″ and may send programming updates to processors of these components (e.g., processor 1110 or control units), for example.

Where multiple components (e.g., 1100, 1100′, 1100″, 1150, 1150′, 1150″) are used in one fluid delivery control system 2220, the components may operate independently of one another. In addition or alternatively, the dilution control system 1100 may receive information about itself, e.g., over-dilution or under-dilution such as due to a worn out or occluded metering device nozzle, and sends this information to the gateway 2210 for taking action. For instance, the gateway 2210 may instruct a second component 1100′ to deliver a mixed solution therefrom so as to compensate for the problems at the dilution control system 1100. In addition, the processor 1110 of the dilution control system 1100 may send information to the communications gateway 2210 indicating that the dilution control system 1100 requires maintenance or service. In addition or alternatively, the components (e.g., 1100, 1100′, 1100″, 1150, 1150′, 1150″) may communicate directly with each other for assisting or controlling operation of their respective electrical components, e.g., solution delivery system 1120 or control valves. In this example, the processors or control units of the respective components 1100, 1100′, 1100″, 1150, 1150′, 1150″ may be configured to communicate with one another, for instance using the disclosed near range communication technologies, and one or more of the processors may send control signals to the other component for subsequent interpretation and generation of a control signal as described herein.

Some components may be responsible for sensing conditions that may impact operating parameters of the level sensing system 1150 or the dilution control system 1100 (e.g., water usage, solution usage, water temperature), while others may use the sensed information to dynamically adjust the operation of the level sensing system 1150 (e.g., to adjust a metering rate or send an alert about a state of level sensing system) or the dilution control system 1100 (e.g., to decrease water, increase solution, deliver cold water) or to determine whether the component operates at all. Accordingly, examples of communicative coupling between the communications gateway 2210 and components 1100, 1100′, 1100″, 1150, 1150′, 1150″ may include providing sensed information such as temperature, humidity, pH level, solution supply level, dilution level, or soil level, soil type, age, wear, or operational status, from one component to the gateway 2210. The gateway 2210 may interpret the information, and generate control signals for operation of one or more of the components 1100, 1100′, 1100″, 1150, 1150′, 1150″. For instance, the processor 1110 of the second component 1100′ may sense temperature information regarding ambient temperatures, water temperatures, solution temperatures, and/or mixed solution temperatures, and may transmit this sensed information to the gateway 2210 for use in adjusting the operating parameters of the dilution control system 1100 or the level sensing system 1150′, such as to adjust the temperature of the motive fluid or increase or decrease an amount of solution used in the mixed solution. In addition or alternatively, the communications gateway 2210 may serve as a communications relay between the components without interpreting the information, and the processor 1110 of the dilution control system 1100 or the control unit of the level sensing system 1150 may interpret the received information and generate a control signal accordingly.

In FIG. 8B, the external controller 1101 may optionally be coupled to the dilution control system 1100 as well as other components 1100′, 1100″, each via connection 1102, which may be a multi-conductor cable often called a “home run cable”. The components 1100, 1100′ and 1100″ of the fluid delivery control system 2220 may each be coupled to the communications gateway 2210 via a serial connection 2211, such as a MODBUS RTU serial connection. The communications gateway 2210 may be directly coupled to the external controller 1101 via coupling 2212, such as local area network (LAN) connection. The components 1100, 1100′, 1100″ may operate independently of one another as described herein, and optionally may operate in concert with one another, for example, by way of the communications gateway 2210 and the serial connection 2211. In some implementations, the components 1100, 1100′, 1100″ may be communicatively coupled via peer-to-peer connections such as near range communications including Wi-Fi, Bluetooth® or LoRa, RFID, NFC, ANT, Zigbee, or WLAN or via long range communication equivalents such as WAN.

Multiple communications gateways 2210 may be connected to a network 2200 over the internet. Local network connections between the components 1100, 1100′, 1100″ and the communications gateways 2210 may include but are not limited to serial connection such as RS485 connections, Ethernet/LAN, Wi-Fi, Bluetooth©, mobile data connections, and expandable connections.

In some implementations, the network 2200 may transmit information to a user interface related to connectivity, usage, diagnostics, and so on for the dilution control system 1100 at the various fluid delivery control systems 2220 having a respective communications gateway 2210. The user interface may be delivered through a web application. The user interface may be graphically configured to include information about each of the components 1100, 1100′, 1100″ at a given fluid delivery control system 2220, along with operating parameters such as: solution name, injector used, dilution setting, sensed tracer or dilution levels, alert settings, sensor connectivity, etc. The graphical interface may enable the user to set alerts and configure parameters such as dilution settings.

In some implementations, a user may transmit information to the network 2200 via the user interface, and for instance, may make product orders or request service calls for addressing problems at the various fluid delivery control systems 2220. Due to the ability of the communications gateway 2210 to provide information about individual components 1100, 1100′, 1100″, each having their own unique ID, product orders may identify a specific component where the order is to be delivered and used.

The network 2200 may receive periodic updates from the communications gateway 2210, such as weekly, and the network 2200 may be configured to aggregate this information for reporting. Critical conditions such as inventory levels and key maintenance events may be sent more frequently to the network 2200. In addition or alternatively, the network 2200 and/or the communications gateway 2210 may be communicatively coupled to bar code readers, automatic inventory reconciliation, in bay applicators, custom solution containers, maintenance logs and so on. The network 2200 may use collected information for reporting, advanced analytics and predictive statistics (e.g., based on environmental factors).

The disclosed embodiments may be combined with the features of the sensing and control systems and methods of the disclosure of U.S. Publication No. US 2021/0349482 A1 is incorporated herein by reference for any useful purpose.

Implementations where a metering device is configured to adjust a cross-sectional size of the flow path through which the concentrated chemical passes and which may be coupled to in-feed lines of a chemical delivery system, e.g., at solution inlets of mixing chambers, injectors or other mixing devices, are disclosed in US 2019/0022607 A1, the disclosure of which is incorporated herein by reference for any useful purpose.

Various changes may be made in the form, construction and arrangement of the components of the present disclosure without departing from the disclosed subject matter or without sacrificing all of its material advantages. The form described is merely explanatory, and it is the intention of the following claims to encompass and include such changes. Moreover, while the present disclosure has been described with reference to various embodiments, it will be understood that these embodiments are illustrative and that the scope of the disclosure is not limited to them. Many variations, modifications, additions, and improvements are possible. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. An insert assembly configured to be coupled to a container having a closed top and an open port, the insert assembly comprising:
an engagement mechanism, the engagement mechanism comprising:
a lower housing portion with an exterior sidewall comprising a coupling configured to be coupled to the port; and
an upper housing portion configured to engage with the lower housing;
a fluid distribution mechanism configured to be rotatably arranged between the upper housing portion and the lower housing portion, the fluid distribution mechanism comprising:
a plurality of fluid connectors configured to transmit fluid therethrough, each of the plurality of fluid connectors comprising at least first port configured to be coupled to a first fluid line and at least a second port configured to be coupled to a second fluid line; and
a sleeve defining an opening,
wherein the engagement mechanism and the fluid distribution mechanism are rotatable relative to each other around a longitudinal axis of the engagement mechanism, whereby during a coupling operation in which the coupler of the lower housing portion is coupled to the port, the engagement mechanism is rotatable around the longitudinal axis relative to the fluid distribution mechanism, and whereby after the coupling operation, the fluid distribution mechanism is rotatable relative to the engagement mechanism and the container.

2. The insert assembly of claim 1, wherein the sleeve is configured to receive an elongated tube such that the elongated tube extends from an exterior of the container into an interior of the container.

3. The insert assembly of claim 2, wherein the elongated tube is a component of a sensor assembly.

4. The insert assembly of claim 1, wherein the first fluid line is configured to extend from an exterior of the insert assembly and distribute fluid from the container, and the second fluid line is configured to extend into a container interior.

5. The insert assembly of claim 1, wherein the coupling comprises at least one threading arrangement defined in the exterior sidewall, and wherein the insert assembly is configured to be threadedly coupled to the port as the engagement mechanism rotates around the longitudinal axis.

6. The insert assembly of claim 5, wherein the threading arrangement comprises a first threading arrangement arranged on a first portion of the sidewall and having a first thread type, and a second threading arrangement arranged on a second portion of the sidewall and having a second thread type different from the first thread type.

7. The insert assembly of claim 1, wherein a distal end of each of the second fluid lines is coupled to a valve assembly.

8. The insert assembly of claim 7, wherein the valve assembly is coupled to a valve attachment mechanism comprising a receiving region for releasably receiving the valve assembly.

9. The insert assembly of claim 8, further comprising an elongated tube extending through the sleeve, wherein the valve attachment mechanism is configured to couple to a distal end of the elongated tube to form a distal assembly, and wherein the distal assembly is configured to be inserted into the port and rest at or near a bottom surface of the container.

10. The insert assembly of claim 9, wherein the valve attachment mechanism is configured to be fixedly arranged along an exterior sidewall of the elongated tube.

11. The insert assembly of claim 1, wherein an elongated tube extends through the sleeve, wherein each of the second fluid lines is coupled to the elongated tube by a tube attachment mechanism, the tube attachment mechanism fixedly arranged along an exterior sidewall of the elongated tube and comprises receiving regions for releasably receiving each of the respective second fluid lines, and wherein the tube attachment mechanism, each of the second fluid lines, and the elongated tube form a conduit assembly, and wherein the conduit assembly is configured to be inserted into the port and rest within the container.

12. The insert assembly of claim 1, wherein the fluid distribution mechanism comprises a flange extending radially relative to the longitudinal axis, the flange supported by and rotatable relative to a bearing surface of the engagement mechanism around the longitudinal axis.

13. An insert assembly for fluid management, the insert assembly comprising:
an engagement mechanism, comprising a housing and a coupling;
a fluid distribution mechanism comprising a plurality of fluid connectors configured to transmit fluid therethrough and a sleeve defining an opening, wherein the fluid distribution mechanism is configured to be rotatably coupled to the housing such that the engagement mechanism and the fluid distribution mechanism are rotatable relative to each other around a longitudinal axis of the engagement mechanism;
an elongated tube extending through the sleeve;
at least one valve coupled to the plurality of the fluid connectors by a corresponding fluid line; and
an attachment mechanism coupled to a distal end of the elongated tube, the attachment mechanism comprising receiving regions for releasably receiving each of the at least one valve, wherein the attachment mechanism, the elongated tube and the at least one valve form a distal assembly, and wherein the distal assembly is configured to be inserted into a port and rest at or near a bottom surface of a covered container.

14. The insert assembly of claim 13, wherein the coupling of the engagement mechanism is configured to be coupled to corresponding coupling of the port of the covered container.

15. The insert assembly of claim 13, wherein the at least one valve comprises a plurality of valves.

16. The insert assembly of claim 13, wherein the at least one valve is configured as a foot valve.

17. The insert assembly of claim 13, wherein the elongated tube comprises a sensor at a proximal end and a cap at the distal end, and wherein the elongated tube contains a float within an interior thereof, the float configured to float on a surface of fluid and the sensor configured to sense a position of the float within the tube for determining a level of fluid in the container, and wherein the cap is configured to permit fluid to enter and exit the elongated tube and retain the float within the interior of the elongated tube.

18. An insert assembly for fluid management, the insert assembly comprising:
an engagement mechanism, comprising a housing and a coupling;
a fluid distribution mechanism comprising a plurality of fluid connectors configured to transmit fluid therethrough and a sleeve defining an opening, wherein the fluid distribution mechanism is configured to be rotatably coupled to the housing such that the engagement mechanism and the fluid distribution mechanism are rotatable relative to each other around a longitudinal axis of the engagement mechanism;
an elongated tube extending through the sleeve;
a fluid level sensing system coupled to a first end of the elongated tube, the fluid level sensing system comprising a control unit containing a processor and a sensor communicatively coupled to the processor; and
a float arranged in the elongated tube and configured to be movable,
wherein the sensor is configured to transmit signals to sense a distance between the sensor and the float arranged in the elongated tube when the elongated tube is arranged in a container containing a fluid undergoing egress therefrom such that a level of a fluid within the elongated tube corresponds to a level of the fluid in the container, and
wherein based on a sensed distance between the sensor and the float, the processor is configured to calculate a level of the fluid present in the container during such egress.

19. The insert assembly of claim 18, wherein the processor or another processor is communicatively coupled to a metering device configured to adjust the rate of egress of the fluid.

20. The insert assembly of claim 18, wherein the processor or another processor is communicatively coupled to a flow rate sensor configured sense a flow rate of the fluid contained in a fluid line as the fluid exits the fluid distribution mechanism.
